(19) United States
(12) Patent Application Publication
(10) Pub. No.: US 2007/0043883 A1
(43) Pub. Date: Feb. 22, 2007

(54) Content processing operations, methods, and software relating thereto

(75) Inventors: Neil MacDougall, Bristol (GB); David Murray Banks, Bristol (GB); Russell Perry, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., HOUSTON, TX (US)

(21) Appl. No.: 11/492,808

(22) Filed: Jul. 26, 2006

(30) Foreign Application Priority Data
Aug. 18, 2005 (GB) 0516918.0

(51) Int. Cl. G06F 3/00

(52) U.S. Cl. 710/11

(57) ABSTRACT

A computer processor and associated computer memory which has in the memory a number of existing content processing operations (CPOs) which include associated description of the type of content they can process, and which has installed, and runable on it, a content processing operation protocol software which is capable of identifying the input requirements of input pins of the CPOs, and which can enable the characteristics of outputs of the CPOs to be identified; and which processor also has installed and runable on it CPO binding software which is adapted to reserve the operation of one CPO and provide its output to another CPO, and which has the protocol necessary to promise the services of one CPO to another CPO, the CPO binding software being able to interpret and use the characteristics of the CPOs expressed in the CPO protocol to determine that it is appropriate to link the one CPO with the other CPO to produce a desired overall function.

### RELATED APPLICATIONS

The present application is based on, and claims priority from, Great Britain Application Number 0516918.0, filed Aug. 18, 2005, the disclosure of which is hereby incorporated by reference herein in its entirety.

### FIELD OF THE INVENTION

This invention relates to content processing operations, methods, and software relating to content processing operations.

### BACKGROUND OF THE INVENTION

In this context, content is defined as the data content of an electronic file or a database that can have a processing operation performed on it. In many embodiments, the electronic file will be an image, video file, video stream, sound file, sound stream or other multimedia or rich media file. Alternatively, the electronic file may be a text file, word-processed document, PDF file, metadata document, data set, a combination of any of the above types of file, or any other type of electronic file/data that can be processed.

A content processing operation (CPO) is a single, primitive operation that is performed on content. The content processing operation may be implemented in hardware or software. The operation can take zero or more inputs and generate zero or more outputs. Examples of content processing operations include video transcoding, metadata extraction, indexing services, image processing, wrapping one type of document into another type of document—for example wrapping a PDF file into a MICROSOFT WORD document, and video key-frame extraction. This is not an exhaustive list: just some examples.

Every implementation of a given CPO must adhere to the same CPO definition; it must take the same number of inputs, generate the same number of outputs and use and understand the same configuration parameters in a specified manner.

Content processing is not tied down to a single application domain, and encompasses a broad range of operations, for example metadata extraction, content analysis, content transcoding, and content manipulation.

A content processing component is a component that performs a content processing operation. Content processing components (video transcoders, re-mastering software, image processors, etc) are provided by numerous third party vendors and each have their own application programmer's interface (API). The API's can vary from vendor to vendor. Products from different vendors define things in different ways, for example, they use different programming languages, different formats, different terminology, expose their interfaces in different ways. Also, each content processing component can have its own proprietary interface and its own mechanisms for configuration and usage.

As an example of how different vendors can define things in different ways, vendor A may provide a content processing component with an API that defines a parameter as the “Smoothing Factor” to define the level of smoothing and accept a value between 0 and 255. The API associated with a similar content processing component provided by vendor B may refer to an equivalent parameter as the “Level of Smoothing”, and accept a percentage value between 0 and 100.

There exists a desire to link together content processing components to form a single pipeline/workflow to perform a sequence of content processing operations on a piece of content to achieve a desired output.

Problems can arise when arranging sequences of content processing components. It takes a degree of skill by a software developer to successfully link the components together and match compatible inputs and outputs of neighbouring components. This can result in a system where the design work in producing the system is not easily re-usable as it is tied to particular components from particular vendors. If a component from one vendor is replaced by a similar component from another vendor, the system may no longer work, for example as the replacement component may require data in a different format to perform the same operation. For example, a parameter of a component produced by a first vendor may be required as an integer value between 0 and 255, whereas the equivalent parameter of a component produced by a second vendor may be required as a percentage value between 0 and 100, as discussed above.

The lack of re-usability of a series of bespoke developed CPOs in different, analogous situations, can result in new software having to be developed each time a series of content processing operations are desired to be linked together to provide solutions for different problems. Existing software that has been developed as a solution for a previous problem may not be re-used for subsequent problems, as the solutions are restricted to the implementation of the API associated with the specific components that have been used to provide the earlier solution.

Furthermore, a client who sets a content processing problem to be solved may specify a vendor and or certain content processing components that they wish to be used in the solution to their problem. A client may specify a vendor and or component based upon such considerations as cost and quality. A client specifying certain vendors and components may mean that a previously developed solution using different components may not be suitable to meet the client's needs. The designer of a system intended to meet a customer's needs may have to accept hardware, or input/output, or system constraints imposed on them by the customer.

### PRIOR ART

Prior art in the field of content processing is plentiful. Any selection from it uses hindsight. An example of a prior art content processing component is Microsoft Filter Graphs (part of DirectX). This system allows a user to build and test filter graphs and has a single execution model for graphs of components. This system is tied to the Microsoft platform and cannot be used with other programming languages or non-Microsoft platforms.

### SUMMARY OF THE INVENTION

According to a first aspect of the invention there is provided a computer processor and associated computer memory which has in the memory a number of existing content processing operations (CPOs) which include associated description of the type of content they can process, and which has installed, and runable on it, a content processing operation protocol software which is capable of identifying the input requirements of input pins of the CPOs, and which can enable the characteristics of outputs of the CPOs to be identified; and which processor also has installed and runable on it CPO binding software which is adapted to reserve the operation of one CPO and provide its output to another CPO, and which has the protocol necessary to promise the services of one CPO to another CPO, the CPO binding software being able to interpret and use the characteristics of the CPOs expressed in the CPO protocol to determine that it is appropriate to link the one CPO with the other CPO to produce a desired overall function.

According to a further aspect of the invention there is provided a method of making a computer program product comprising:
determining what the software is to be able to do;
establishing that at least elements of functionality which can be used to deliver the functionality required can be produced using content processing operations (CPOs) that are already in existence and that are available for use;
creating a software interface container for at least some CPOs which interacts with the said at least some existing CPOs to expose their properties in a common format, non-native to said at least some CPOs; and
using the non-native interface container to mediate communication between a plurality of said at least some CPOs so as to produce a software program product which uses interactions between said existing CPOs to perform the functionality required of the computer program product.

According to a further aspect of the invention there is provided a method of using a plurality of existing content processing operations (CPOs) to perform a composite content processing operation, the CPOs having API's which require inputs and/or outputs to be in different formats, the method comprising expressing the inputs and outputs of each API in a common format by interposing a translation container between CPOs and their interaction with the rest of a computer system, each translation container expressing the input(s), needed for its CPO, and the output(s) provided by its CPO, in a common format that is not the native format for the CPO with which it interfaces.

According to a further aspect of the invention there is provided a computer-implemented method of making software instructions to perform a function made from a plurality of content processing operations, the method comprising using a library of a plurality of content processing operations each with their functionality and input requirements expressed in a common format, this common format being achieved by: using a translation wrapper on native content processing operations which have their functionality and/or input requirements expressed in a native format that is not said common format to expose to a computer system the functionality and input requirements in terms of the common format; and
using binding manager functionality software to negotiate an operation binding contract between the operation of a first content processing operation and the operation of a second content processing operation so as to cause one of the CPOs to provide processed data to another of the CPOs, in use.

According to a further aspect of the invention there is provided a process for data content processing comprising combining existing content processing operations which interact with inputs or outputs from each other, and which do so via an intermediary translation protocol which interfaces their own native input/output protocol and translates their requirements or product characteristics into the translation protocol which is operable with all of the existing CPOs, the output of a first existing CPO being provided as an input to a second existing CPO which produces an output using the input from the first CPO.

In some embodiments an existing CPO may be a quantum, atomic, or primitive CPO, or a CPO that is otherwise not divisible into constituent CPOs.

The process may comprise searching a library of available existing/atomic CPOs that either operate natively using the translation protocol or that have their native interface wrapped by translation protocol wrapper. The existing/elemental CPOs may be wrapped in a translation protocol interface individually, or a translation protocol interface may be interposed between a plurality of existing/atomic CPOs and the rest of a network.

The process may comprise a user inputting a demand to a system requesting that a particular CPO be performed on some specific content.

The system may have a demand controller/director which ascertains whether a library of known existing CPOs includes the requested CPO, and if so causes a selected CPO (which may be complex, non atomic) to perform the particular CPO on the specific content.

If the demand director does not ascertain that the requested CPO already exists in the available library of existing CPOs, or of it does exist but the existing desired CPO is not available for some reason (e.g. it is already busy), the demand director may cause a new CPO to be created. This may involve copying an existing CPO to make a second resource available. It may involve linking together the operations of a plurality of atomic CPOs to form a complex CPO, being a multi-existing CPO construct. The demand director may determine which combination of existing CPOs (elemental or complex) are needed, in what order, to perform the requested CPO. The demand director may then cause the necessary existing CPOs to be linked in the necessary way to produce the requested CPO.

The demand director may use the library of existing CPOs, optionally with information on their availability for use, to determine a work flow path for the data to be processed, and may instruct the existing CPOs to operate in series and/or parallel on the data in a specified order to produce the desired CPO. In some situations an existing CPO may be able to interact with another CPO in one of a number of different data formats, and an appropriate data format, from the available formats, within the capabilities of both the first and second CPO is used as the input/output data format. (For example, a first CPO may be able to output an image as a jpeg, tif, bitmap, or pdf, and a second CPO may be able to accept as input an image in bitmap form or in pdf, but not in jpeg or tif. In this example the first CPO is instructed to output the image in pdf or bitmap. If a third CPO (needed in the chain of CPOs), further downstream in the processing operation could only work in bitmap, then this may (or may not) cause the output of the first CPO to be in bitmap form. An alternative would be to work in the “wrong” form (e.g. pdf) and convert, using a converting CPO, to the “right” form upstream of the CPO that requires bitmap form. Or to create a CPO that performs the function of the third CPO but which also, bundled as part of its operation, converts images, in for example pdf, to bitmap (the right form).

There may be a central demand director which specifies the processing route/chain using the known existing CPOs. Or the route/chain may be created “on the fly” as the processing is performed. As an example, it may be determined (e.g. by a demand director, or perhaps a requested complex CPO constructor—no direction to specific CPO addresses as such) that a requested data content processing operation can be performed if existing CPO “a” is performed followed by existing CPO operation “b”. The CPO constructor may direct a specified, addressed, first CPO to perform its function “a” on the data, or it may simply broadcast a message to a group of CPOs that it requests one with the capability to do function “a” to volunteer to perform that function. Either way, a first CPO performs function “a” on the data. The first CPO could then broadcast a request for a CPO capable of performing function “b” to take the data, processed by itself (with function “a” already performed on it) and perform function “b” on it. Those CPOs who receive the broadcast request can determine if they can perform function “b”, and/or if they have available capacity to perform function “b”, and volunteer to perform that function (and do it), thereby producing processed data that has had the requested “a” and “b” processing on it.

The “a and b” CPO route may now be added to the library, but it is not truly an integrated CPO. The library may contain integrated CPOs that do not need to negotiate with others to provide their function, and details of synthesised complex CPOs which can provide extra functional operations.

As well as, or instead of, contracting to accept inputs, the CPOs (or their controller) may contract to provide outputs. For example, the chain of existing CPOs to be used could be grown from the end backwards. (Find a CPO that can do “b” and look for one that can do “a”, and then trigger the “a” CPO operating on the data and pushing it to the “b” CPO).

It will be appreciated that the CPOs in a synthesised workflow do not have to pass on processed data to another CPO, for example they could provide an input needed to process the data in a CPO.

As well as, or instead of, contracting to provide services dynamically, or “on the fly”, in real time, as and when services are requested, the system may be able to construct future contracts: CPOs reserving their activity at a future point in time to perform their function. This can avoid a complex, synthesised, CPO from being unable to complete its task due to an existing CPO component of the synthesised pathway being unavailable at the appropriate moment in time.

The data CPO of a CPO may require the data to be of a certain type, and data to be processed may be typed. The establishment of a contract with a CPO to perform an operation on data may include an evaluation of the type of data to ensure compatibility. Data may be stored with a type marker encoded with it.

CPOs in a workflow may be in the same computer or processor, or may be distributed over a network of computers or processors, which may be a LAN, WAN, MAN, or the like. They may be distributed over the Internet or Worldwide Web.

According to a further aspect of the invention there is provided software arranged to be interposed in a communication channel between a content processing operation and a user accessing the content processing operation, wherein the software translates a native interface associated with the content processing operation into a non-native interface that is exposed to the user.

The software can be arranged to generate a content-processing workflow by linking together content processing operations.

The non-native interface may expose a number of pins that have one or more types associated with them. A user may bind content to the pins by value, by reference or by stream.

A pin, also known as a port, can be considered to be a logical access point that can exchange data of a specified type or types (for example, video, audio, image). The exchange of data includes accepting data, generating data, or otherwise transporting data. The pin can be a logical connection point that is embedded in software.

The software may comprise a binding manager that is arranged to enable the user to reserve content processing operations, create binding proposals, respond to binding offers, and wire up pins.

The software may be arranged provide a binding contract that provides access for the user to the content processing operation.

XML schema may be used to express the non-native API. The non-native API may support the http protocol.

The non-native interface may provide one, some, or all of the following methods:
i.) GetOperations—Returns a set of primitive content processing operations supported by the software;
ii.) GetComposites—Returns a set of composite content processing operations supported by the software;
iii.) RequestOperationBinding—Binds to a primitive or composite content processing operation;
iv.) UpdateBinding—Binds pins of a content processing operation;
v.) InvokeOperation—Invokes a primitive or composite operation in a synchronous manner;
vi.) ReleaseBinding—Releases a binding to a primitive or composite content processing operation;
vii.) GetBinding—Returns binding information for a given binding; and
viii.) GetProtocols—Returns a set of protocols supported by the software.

According to a further aspect of the invention there is provided the act of loading onto a memory device the software of a previous aspect of the invention.

According to a further aspect of the invention there is provided a method of developing a content processing workflow comprising using the software according to a previous embodiment of the invention to bind content processing operations together.

According to a further aspect of the invention there is provided a system comprising one or more content processing operations and software arranged to provide a non-native interface to the content processing operations, wherein a user can use the software to access the one or more content processing operations.

### BRIEF DESCRIPTION OF THE DRAWINGS

Some embodiments of the invention will now be described by way of example only, with reference to the accompanying drawings, of which:—

FIG. 1 shows schematically a prior art content processing component;

FIG. 2a shows schematically a prior art system for processing content;

FIG. 2b shows schematically how prior art content processing components can be connected together;

FIG. 3a shows schematically a content processing component according to an embodiment of the present invention;

FIG. 3b shows schematically a content processing component according to an embodiment of the present invention;

FIG. 4 shows schematically how content processing components according to an embodiment of the present invention can be connected together;

FIG. 5 shows schematically how content processing components according to another embodiment of the present invention can be connected together;

FIG. 6 shows schematically a content processing operation according to an embodiment of the invention;

FIG. 7 shows schematically a content processing operation according to an embodiment of the invention;

FIG. 8 shows schematically a content processing workflow according to an embodiment of the present invention;

FIG. 9 shows schematically a content processing operation according to an embodiment of the invention;

FIG. 10 shows schematically a content processing operation according to an embodiment of the invention;

FIG. 11a shows schematically a content processing operation according to an embodiment of the invention;

FIG. 11b shows schematically a content processing operation according to an embodiment of the invention;

FIG. 12 shows schematically a content processing operation according to an embodiment of the invention;

FIG. 13 shows schematically a composite content processing operation according to an embodiment of the invention;

FIG. 14 shows schematically a composite content processing operation according to an embodiment of the invention;

FIG. 15 shows schematically a composite content processing operation according to an embodiment of the invention;

FIG. 16 shows schematically a binding exchange according to an embodiment of the present invention;

FIG. 17 shows schematically a content processing workflow according to an embodiment of the present invention;

FIG. 18 shows schematically a content processing operation according to an embodiment of the invention;

FIG. 19 shows schematically a binding exchange according to an embodiment of the present invention;

FIG. 20 shows schematically a content processing operation according to an embodiment of the invention;

FIG. 21 shows schematically a binding exchange according to an embodiment of the present invention;

FIG. 22 shows schematically a content processing operation according to an embodiment of the invention;

FIG. 23 shows schematically a binding exchange according to an embodiment of the present invention;

FIG. 24 shows schematically a binding exchange according to an embodiment of the present invention;

FIG. 25 shows schematically a content processing operation according to an embodiment of the invention;

FIG. 26 shows schematically a binding exchange according to an embodiment of the present invention;

FIG. 27 shows schematically a binding exchange according to an embodiment of the present invention;

FIG. 28 shows schematically a content processing workflow according to an embodiment of the present invention;

FIG. 29 shows schematically a content processing workflow according to an embodiment of the present invention;

FIG. 30 shows schematically a binding exchange according to an embodiment of the present invention;

FIG. 31 shows schematically a content processing operation according to an embodiment of the invention;

FIG. 32 shows schematically a binding exchange according to an embodiment of the present invention;

FIG. 33 shows schematically a binding exchange according to an embodiment of the present invention;

FIG. 34 shows schematically the lifecycle of a content processing operation according to an embodiment of the present invention;

FIG. 35 shows schematically a translator according to an embodiment of the present invention;

FIG. 36 shows schematically a content processing operation according to an embodiment of the invention;

FIG. 37 shows a flow diagram of the steps carried out when performing a method according to an embodiment of the present invention; and

FIG. 38 shows a flow diagram of the steps carried out when performing another method according to an embodiment of the present invention.

### DETAILED DESCRIPTION OF SOME EMBODIMENTS OF THE INVENTION

Prior Art Discussion

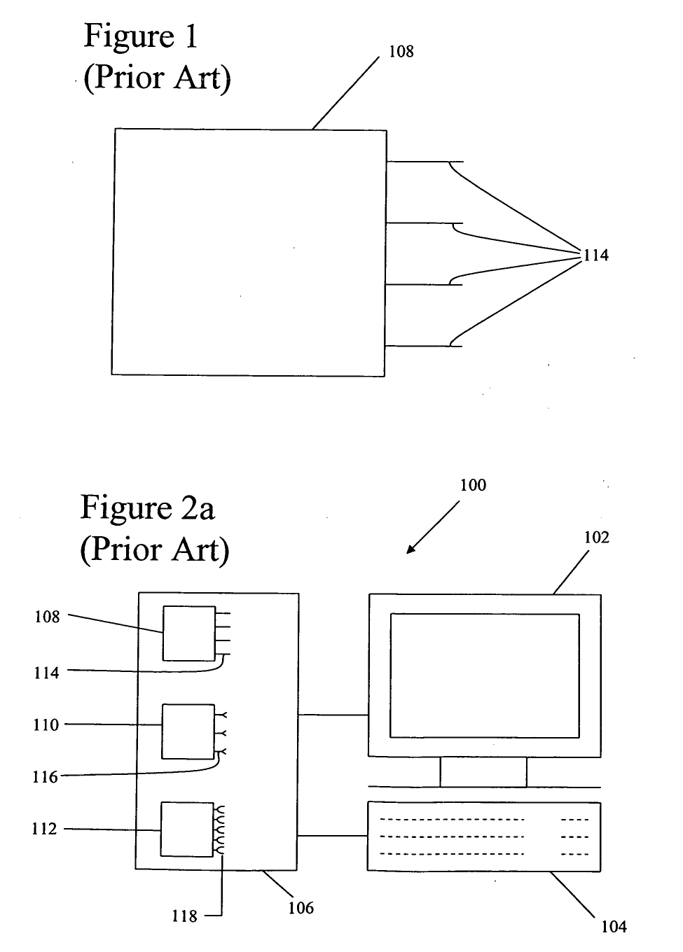

FIG. 1 shows a prior art content processing component 108. Content processing component 108 has four connections 114. In some embodiments the connections are referred to as pins or ports. A content processing component can have any number of connections/pins that can be inputs, outputs or settings. The pins provide a mechanism by which a content processing component exposes that it either consumes or produces data of a particular type.

In some embodiments, the content processing component 108 consists of a number of logic gates, or other electronic components, on an integrated circuit (IC). The content processing component 108 is really a logical unit of functionality within an IC, and the connections 114 are logical access points and not necessarily physical pins on the IC. The four logical connections 114 may each have their own physical pin on the IC, or in other embodiments, one physical pin on the IC can be used to represent a number of logical connections 114.

Some pins may be optional and some pins may be mandatory. Some optional pins may have default settings that they assume if they are not connected to anything providing an input to that pin.

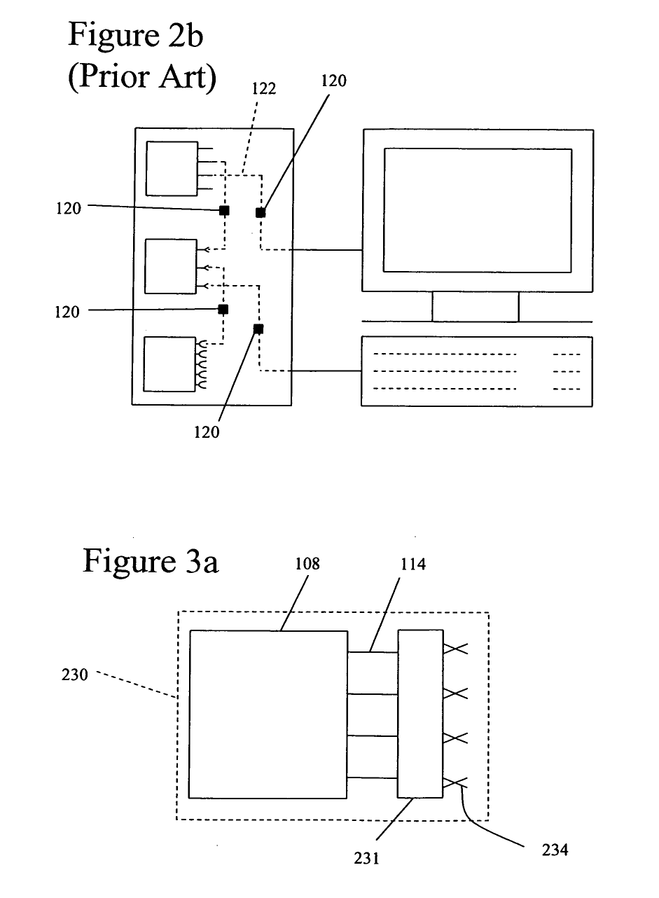

FIG. 2a shows schematically a prior art system 100 that can be used for processing content. The system 100 consists of a monitor 102, a keyboard 104 and a PC 106. Stored in memory of the PC 106 are three content processing components 108, 110, 112.

Content processing component 112 is arranged to receive a video stream and convert the video stream into an mpeg file type. Component 112 is a video transcoder. The component 112 has five pins, consisting of one mandatory output pin that outputs a video file, and four optional input pins that can define properties of the video file that is to be transcoded. In this embodiment a video stream input does not have an input pin associated with it, as the component 112 is constantly connected to a video camera (not shown).

Content processing component 112 is an example of a component that does not have an input pin associated with the video input. In this embodiment the video camera is the originator of the data, and therefore does not require a pin associated with it. In other embodiments a video stream input may have an associated input pin that can be connected to a device that provides a video stream.

Content processing component 110 is arranged to overlay text onto a video file. Component 110 is an example of an image processor. The component 110 has an input pin that is arranged to accept a video file, another input pin that is arranged to accept text to overlay on the video, and an output pin that is arranged to output a video file with the text overlaid on it. The input pin that is arranged to accept text may accept text as a stream from a keyboard, or as a text file.

Content processing component 108 is arranged to add a border to the video. Component 108 is another example of an image processor. The component 108 has one mandatory input pin that accepts a video file, one mandatory output pin that outputs the video and two optional input pins that can be set to define properties of the border. In other embodiments the output does not have an output pin associated with it, as the component 108 can be permanently connected to an output device, for example a display device or a satellite dish to transmit the data. Such components cannot link to any other output devices.

The three content processing components 108, 110, 112 are each produced by a different vendor and have different application programmer's interfaces (API's) 114, 116, 118. The API's 114, 116, 118 are shown schematically as having different shaped connectors to indicate that they are designed to be connected/configured in different ways. The API's 114, 116, 118 are only compliant with interfaces of other content processing components that have API's of the same type, or with the outside world in a manner that is compliant with the type of API present on the content processing component.

If a programmer wishes to connect together any two of the content processing components 108, 110, 112, for example to transcode a video and then overlay text onto the video, a degree of skill is required by the programmer to write a program that enables the content processing components 108, 110, 112 to communicate with each other. For example, data that is output by a first content processing component may need to be translated/mapped into a format that is compatible with the input of a second content processing component.

Also, the programmer has to submit a request to use the content processing component in a manner that is compliant with the component-specific API: a request that complies with the criteria for the API of one component may well not comply with the necessary criteria to elicit a meaningful response from a different component using a different API.

It is not as simple as just being able to communicate with the appropriate API 114, 116, 118; it is deeper than that. The entire data structure, organisation of data, is different in the three API's. This makes it difficult for a programmer/user to interact with a number of different components, having different API's. Interoperability with a plurality of different components that have different API's is not provided by this prior art system.

FIG. 2b shows schematically a prior art system of how content processing components 108, 110, 112 can be connected together using links 122, as well as connecting content processing components 108, 112 with the monitor 102 and keyboard 104 respectively.

A link 122 is a communication channel/path. The communication channel may be a connection over a LAN, WAN etc., or it may be a physical hardware path. The communication channel may be within a single device, or it may be between different devices.

A set of content processing components are connected together to provide a content processing solution/workflow to a given content processing problem, and can be considered as a content processing workflow or pipeline.

Bespoke pieces of software 120 are written by a programmer to enable the API's 114, 116, 118 to communicate with each other and the outside world. The bespoke pieces of software 120 are specific to the two devices/components/interfaces that they link, and the same software 120 cannot be used with different devices/components/interfaces.

The bespoke software 120 may convert data types, programming languages, configuration parameters, number of inputs and/or outputs that are compatible with a first content processing component, to corresponding types that are compatible with a second content processing component.

Where a software development company provides content processing workflows for a specific problem, it is not possible to re-use content processing workflows that have been developed as a solution for an earlier problem unless exactly the same vendor's products are used with exactly the same API's in the solution to a subsequent problem. If exactly the same API's are not used, then the bespoke pieces of software created for the earlier solution will not be able to be used for future content processing workflow solutions and new pieces of bespoke software 120 will be required for each workflow solution.

The present invention flows from a realisation that it is possible to translate the API that is native to a content processing component into an API that is not native to the content processing operation, to enable all content processing components that expose the non-native API to be connected together in a way which allows them to interoperate without the requirement for bespoke software to be written. It is possible to provide a platform that makes it easier to build content processing workflows as solutions to content processing problems. When API's are translated this way (into what might be thought of as expressions in an intermediate, common (as in mutual) language), we find that it is possible to achieve a greater level of interoperability with content processing components provided by different vendors than previous approaches. Of course, the non-native API may be the same as the native API for a content processing component, as long as the API is consistent with API's associated with other components according to embodiments of the invention.

The realisation that providing a translator to translate a native API associated with a content processing operation to a non-native API according to the invention for communication with other API's/components/peripheral devices is somewhat startling. It provides a cheap, readily available, and convenient way of providing greater interoperability/access across a plurality of content processing components.

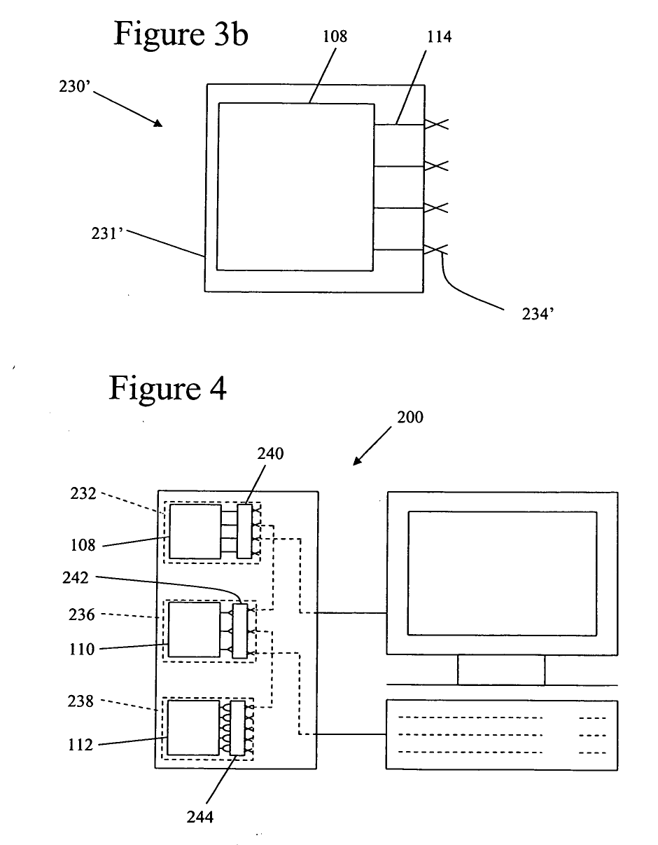

FIG. 3a shows schematically a content processing component 230 according to an embodiment of the present invention. The content processing component 230 comprises a prior art content processing component 108 with it's native API 114 and a translator 231 that exposes an API 234 that is non-native to the prior art content processing component 108. The non-native API 234 exposes the functionality of the content processing component 230 in the same way as other non-native API's associated with different content processing components. In many embodiments the native API 114 will be different to the non-native API 234, however, in some embodiments the native API 114 may be the same as the non-native API 234.

Where the native API 114 is the same as the non-native API 234, the translator 231 ensures that the content processing component 230 according to this embodiment of the invention can communicate with other content processing components according to this embodiment of the invention.

FIG. 3b shows schematically a content processing component 230′ according to another embodiment of the present invention. This component 230′ is illustrated so that the translator 231′ defines a container for the component 230′, and in some embodiments the translator 231′ may also be known as a container. It will be appreciated that there are no functional differences between the components 230, 230′ illustrated in FIGS. 3a and 3b.

It will be appreciated that FIGS. 3a and 3b, and many of the Figures that follow, are schematic illustrations and that the content processing component, it's API and the translator are all defined by pieces of executable computer code/software that are stored in a memory device.

The content processing component 230 is defined by a Content Processing Abstraction that defines, amongst other things, its own namespace, the types of content that the component 230 can accept, and events associated with the content processing component 230. The Content Processing Abstraction will be discussed in more detail later.

Providing a translator 231 exposing its own API 234 enables all content processing components 230 according to embodiments of the present invention to be able to communicate with each other in the same way. The API's 234 will always have the same connection parameters. When linking the pins of content processing components according to embodiments of the present invention together, there is no requirement to create pieces of bespoke software that enable the content processing components to be able to communicate with each other. The piece of software that defines the translator for a content processing component can be re-used when the component is used as part of a different content processing workflow. All each content processing operation (CPO) (logical unit) cares about is whether it has the correct inputs in the correct format to its pins, and an appropriate place to send outputs that it may generate (i.e. that its output pins connect to something).

How the input pins get their inputs, and what happens to the output data/signal is not a concern for any particular CPO.

Furthermore, content processing workflows that have been created as solutions to earlier problems can be used as a part of a content processing workflow solution to a subsequent problem. This reduces the amount of new software that has to be written to provide content processing workflows to content processing problems, as previously developed software can be re-used. This can save any, some, or all of, time, money, development resources, memory resources required, processing power required when developing new software to provide a content processing workflow.

Where a client requests a content processing workflow solution to a content processing problem, using content processing components according to embodiments of the invention can provide a wider choice of components that are available to the client. Content processing components according to embodiments of the present invention are more extensible than prior art content processing components as prior art content processing components require point-to-point integration for specific vendors' products.

FIG. 4 shows a system 200 according to an embodiment of the invention consisting of three content processing components 232, 236, 238 that are used to perform the same overall content processing operation as the prior art system shown in FIG. 2. Each of the components 232, 236, 238 has its own translator 240, 242, 244 that translates the parameters of the native API associated with the components 108, 110, 112 to a non-native API associated with the translator 240, 242, 244.

In this embodiment bespoke pieces of software are not required to be written specifically to connect certain interfaces together. Once a translator 240, 242, 244 has been developed for prior art content processing components 108, 110, 112, any of the prior art components 108, 110, 112 can be used with any other component 108, 110, 112 without having to develop more code in order that they can communicate together. The common “language”, or interface of the non-native API's forced on each CPO achieve interoperability/connectivity of the CPO's.

Having all of the content processing components 232, 234, 236 stored on a single device can provide a quick and easy system for an application developer to develop content processing workflows. No delays are introduced by communicating with different devices, and the single device can act as a stand-alone device.

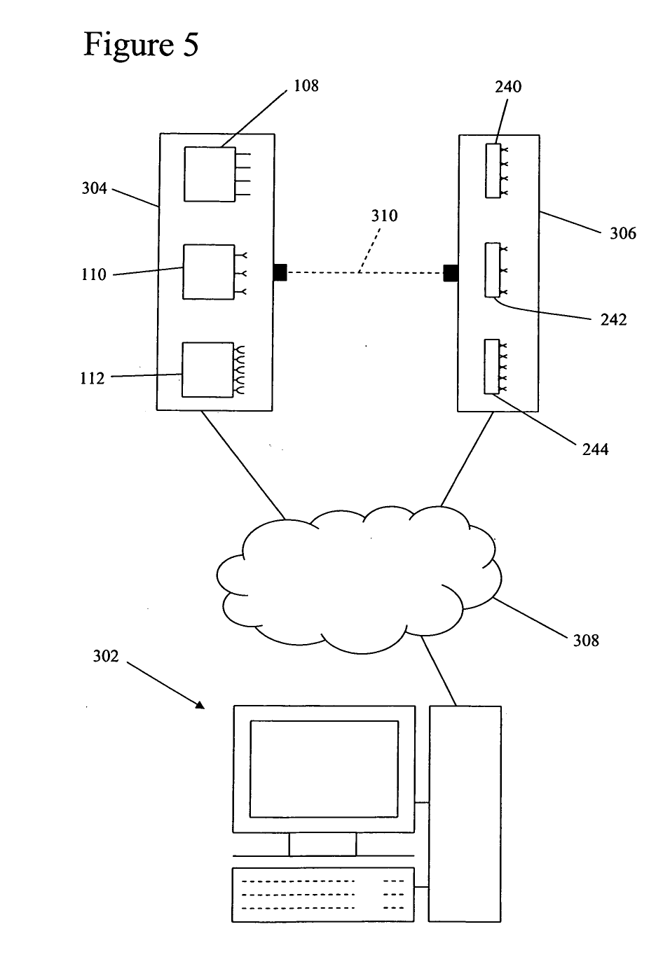

FIG. 5 shows a system according to an embodiment of the invention. The system consists of a PC 302 connected to a first memory storage device 304 and a second memory storage device 306 over a network 308. The network 308 may be wired or wireless. The network may be a Local Area Network, Wide Area Network, Metropolitan Area Network, the internet or any other system that allows data to be exchanged between two devices.

In use, a user uses the PC 302 to develop workflow solutions to perform a sequence of content processing operations using content processing components. Three prior art content processing components 108, 110, 112 are stored on first memory storage device 304 that is connected to the PC 302 over the network 308. Three translators 240, 242, 244 are stored in the second memory device 306 and are arranged to translate the native API's of the prior art components 108, 110, 112 into a common non-native API. It will be appreciated that either, or both, of the memory storage devices could be located in the same device, which could be the memory of the PC 302.

Optionally, the first and second memory storage devices 304, 306 may be the same device, or they may be linked via communication path 310. Alternatively, content processing components distributed over a number of different memory storage devices can be used to provide a content processing workflow. Not all of the components need to be stored on the same memory storage device. Similarly, the translators may also be distributed over a plurality of memory storage devices, or may all be stored on the same memory storage device. As long as the translators are interposed in the communication channel between the prior art content processing components and a user of the content processing components, they can perform an embodiment of the invention.

Using a distributed system as shown in FIG. 5 can provide the advantage that greater functionality can be offered without having to have the same content processing components stored in the memory of individual devices. It can therefore provide cost advantages as there is no requirement to repeatedly store the same components on different devices. Also, less memory is used, and if the operation of a CPO is modified in the future, it does not have to be modified in so many copies.

It will be helpful at this time to specify in more detail the schema employed by aspects of the present invention in order to implement the non-native API. In some embodiments an XML schema is used as part of a web-service model to express the non-native API, although it will be appreciated that other schemas/models could be used instead. The translators (also known as containers in some embodiments) may choose to use a web-services model to be platform independent. They may support HTTP, TCP/IP or SMTP, for example.

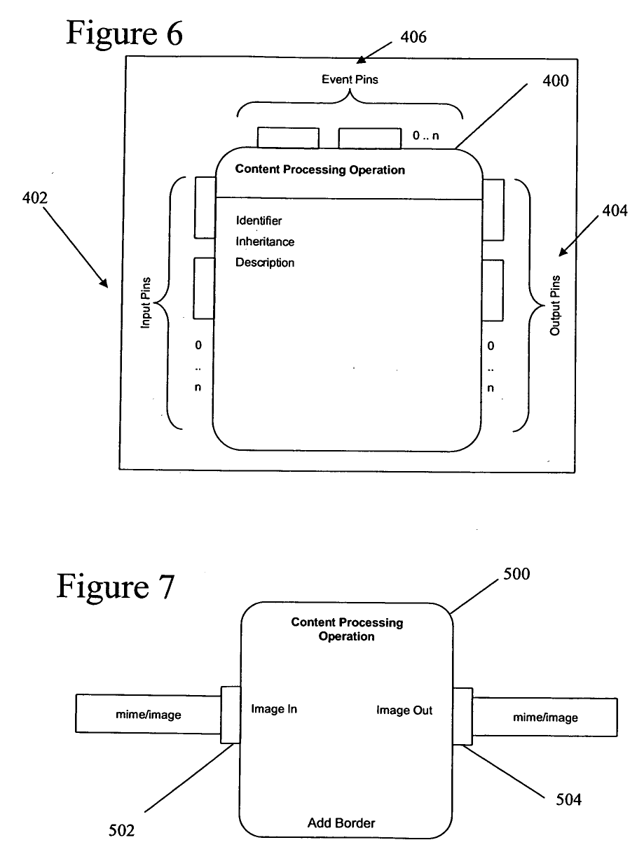

FIG. 6 shows a pictorial representation of a content processing operation (CPO) 400 according to an embodiment of the present invention. The content processing operation 400 exposes it's input pins 402, output pins 404 and event pins 406 as an API that is not native to a prior art content processing operation associated with the content processing operation 400 according to this embodiment of the invention. The CPO can optionally include 0 . . . N input pin definitions, 0 . . . N output pin definitions, and 0 . . . N event pin definitions.

The content processing operation 400 may include a human readable label that describes to the reader what the content processing operation 400 does.

Operation Identifiers

The CPO 400 contains a unique identifier in order that the CPO 400 can be called upon unambiguously to tell CPO's apart. The unique identifier may be a Uniform Resource Indicator (URI), and need not follow any pattern, as long as it is unique. An example of a URI for an image resizing operation might be: http://csf.hpl.hp.com/cpo/image/resize. Using a URI provides a hierarchical identifier for the CPO and fits well into a web-service model. The identifier does not have to be a URI; in some embodiments it may be an arbitrary name.

Operation Inheritance

The CPO 400 also contains inheritance information in order that it is able to inherit information from another CPO. Multiple-inheritance is not supported in this embodiment as it can render the CPO ambiguous and may require a lot of complicated rules to implement successfully. In other embodiments however, multiple-inheritance may be supported.

Operation inheritance is seen as a mechanism to simplify the specification of new content processing operations by allowing inheritance of definitions. This avoids each CPO interface needing to describe everything about itself as it can call in earlier definitions and just describe the differences between itself and the earlier definition.

When a content processing operation inherits from another, it inherits all of the input pins, all of the output pins and all of the event pins. A CPO that inherits from another can override part of the parent's definition. Where optional pins are inherited, these may be made mandatory in the child operation. Mandatory pins in a super operation (an upstream operation) cannot, however, be made optional in the child operation. Converting a mandatory pin into an optional pin may render the CPO unusable without the mandatory pin.

Base Operation

All operations may inherit (either directly or indirectly) from a base content processing operation. This operation defines the set of events that all content processing operations can generate. An example of a base operation's unique identifier might be: http://csf.hpl.hp.com/cpo/system/operation. In some embodiments, if a content processing operation does not define a super operation, then the content processing operation inherits from the base operation.

Example of Inheritance

An example of a child CPO that uses inheritance from a super/parent operation is one that is arranged to process an image by placing a straight black border with a thickness of 10 mm around an image. The child CPO is called “add black 10 mm border” and inherits from a parent CPO called “add border”.

The parent CPO is arranged to place a border around an image, and has a number of optional pins that define characteristics of the border, for example colour, pattern and thickness. The default values for the optional pins in the parent CPO may create a blue curvy border with a thickness of 5 mm.

When the child CPO inherits from the parent CPO, it overrides and disables the default values of the optional pins of the parent CPO that define characteristics of the border. The pins that were optional in the parent CPO are permanently set to define a black straight border with a thickness of 10 mm by the child CPO.

Input and Output Pins

All pins must be uniquely named within a given content processing operation. That is, each content processing operation can only have one pin with any given name. The names are used purely for connecting content processing operations together, and ensure that each pin can be unambiguously identified within a content processing operation. Pins can support any type of data, ranging from simple types such as integers and booleans through to video streams or images. Pins can also support data sets.

Pins are the mechanism by which content processing operations send and receive content.

Typing of Pins

Pins can have one or more types associated with them. The set of types that a pin can support is the complete list of all types that it can process. Where multiple types are supported, the set of types can be weighted, with each type being assigned a non-negative integer priority. A lower priority indicates a preference for a type. Three examples (labeled A, B and C) of type priorities are shown in the table below:

| Type | Example A | Example B | Example C |
|---|---|---|---|
| Type 1 | 1 | 5 | 7 |
| Type 2 | 1 | 5 | 2 |
| Type 3 | 2 | 12 | 1 |

Examples A and B have an equivalent representation of priority. Both examples express an equal preference for Types 1 and 2, and less of a preference for Type 3. These examples illustrate that the values of the integer priorities are not significant, that is they do not need to be contiguous and they do not need to have upper and lower bounds. Example C illustrates a simple type preference where type 3 is the most preferred, type 2 is the most preferred after type 3, and finally type 1 is the least preferred.

Because pins are typed, it is possible to determine at design time of a workflow if an input and output pin are compatible. In some embodiments the party that is accepting an offer makes the choice as to which type to use, and this may involve selecting the type that has the lowest priority for the accepting party, and that is acceptable for both parties.

Pin types are specified using XML Schema. The XML Schema built-in data types can be used to specify pin types, and other types can be built using XML Schema where necessary. Thus example pin types could be (where the namespace prefix xsd refers to the namespace http://www.w3.org/2001/XMLSchema):
xsd:string
xsd:decimal

The Content Processing Abstraction defines its own namespace and XML Schema that refers to a standard set of types that are defined for common pin types. An example of a URI for this namespace may be: http://csf.hpl.hp.com/cpo/baseTypes. The XML Schema associated with this namespace may define types such as “percentage” and “RGB color”.

This namespace may be referenced in the definition for the base content processing operation from which each content processing operation according to an embodiment of the invention can inherit information either directly or indirectly. The standard types are therefore available to all content processing operations according to embodiments of the present invention.

Content processing operations are capable of adding their own types, although standard types should be used wherever possible, as use of non-standard types may reduce the possibility of swap-ability where one content processing operation is capable of being swapped with another content processing operation without requiring bespoke software to be developed to facilitate the swap. The standard set of types may evolve over time.

Alternatively, the set of types may not be weighted and one of the available types may be selected at random.

Content Types

The Content Processing Abstraction defines types for content, such as image and video. The purpose of content types is to ensure that pins are compatible for exchanging content.

The MIME content-type system can be leveraged to represent the media type and sub type information as two parts in the form:
<media type>/<sub type>

The MIME content-type system is defined by RFC2045 (Request For Comments) and RFC2046. RFC's are well known in the art, where an RFC is a document that describes the standards that make the Internet work, and are published on http://rfc.net/ at present.

In this embodiment, the 5 top-level media types from RFC2046 are selected, namely:
Text
Audio
Video
Image
Application

In other embodiments, any selection of media types may be used with the invention.

A single type system expressed using XML Schema is used rather than having two type systems, one for simple types and one for content types. Simple types are expressed using XML Schema as already discussed, and in order to express content types, the MIME types are mapped into XML Schema data types. Thus types are defined in an XML schema document that represents the five top-level media-types as defined by the MIME standard (and shown above). Each of these types is derived from a base type named “mime”. A fragment of the XML Schema that represents the five top-level mime types is shown below:

```
<?xml version=“1.0” encoding=“UTF-8”?>
<xs:schema targetNamespace=“http://csf.hpl.hp.com/1/0/cpo/types/mime/”
xmlns:cpo=“http://csf.hpl.hp.com/1/0/cpo/types/mime/”
xmlns:xs=“http://www.w3.org/2001/XMLSchema”>
  <xs:simpleType name=“mime”>
    <xs:annotation>
      <xs:documentation>Mime base type</xs:documentation>
    </xs:annotation>
    <xs:restriction base=“xs:base64Binary”/>
  </xs:simpleType>
  <xs:simpleType name=“image”>
    <xs:annotation>
      <xs:documentation>Image Mime type</xs:documentation>
    </xs:annotation>
    <xs:restriction base=“cpo:mime”/>
  </xs:simpleType>
  <xs:simpleType name=“video”>
    <xs:annotation>
      <xs:documentation>Video Mime type</xs:documentation>
    </xs:annotation>
    <xs:restriction base=“cpo:mime”/>
  </xs:simpleType>
</xs:schema>
```

As an example, if this schema were referenced in an operation definition with the namespace prefix “mime”, then valid types would be:
mime:image
mime:video

And so forth. In order to represent the sub-types, an XML schema document is defined for each sub-type that derives from the top-level mime type. Thus, we define an XML Schema for the media type “image”. As an example, if this schema is then referenced by an operation definition through the namespace prefix “img”, then this would expose the following types:
img:jpeg
img:gif

The URI for the namespace associated with the XML Schema for the image mime type may be: http://csf.hpl.hp.com/image.

Some content may have restrictions associated with it, and content type can be used to describe such restrictions. Also, “protected content” in relation to rights management and “payment required” may be defined as types.

Type Detail

For some content types, additional type information may be needed beyond the mime type information to provide more information about the specific mime type. As an example, consider the mime type for a device independent bitmap (DIB). With the typing scheme introduced previously, this type can be represented by the xml schema data type:
image:dib

Device Independent bitmaps can support images with a varying number of bits per pixel, typically 8, 16, 24 or 32, and the mime type does not provide this level of detail. Complex types can be created for each of these variations and be derived from the base type image: dib.

The type detail specifies the exact type information. Operations can provide type detail within the type definition for a pin. An example is shown below:

```
<?xml version=“1.0” encoding=“UTF-8”?>
<Operation xmlns=“http://csf.hpl.hp.com/1/0/cpo/”
xmlns:image=“http://csf.hpl.hp.com/1/0/cpo/types/image/”>
  <Identifier>http://csf.hpl.hp.com/1/0/cpo/image/smooth</Identifier>
  <Pins>
    <Input>
      <Pin name=“ImageIn” optional=“False”>
        <Types>
          <Type priority=“1” type=“image:dib”>
            <dib:Detail xmlns:dib=
            “http://csf.hpl.hp.com/1/0/cpo/typs/image/dib/”>
              <dib:BitsPerPixel>24</dib:BitsPerPixel>
            </dib:Detail>
          </Type>
        </Types>
      </Pin>
    </Input>
  </Pins>
</Operation>
```

In this example, the type detail for the pin is specified within the <dib:detail> XML fragment. The namespace for the dib prefix is the URI http://csf.hpl.hp.com/image/din and the content within that fragment conforms to the XML schema associated with the namespace.

Other examples where additional type information may be required is whether or not the content is compressed, and very specific formats that can be associated with video files.

Note that some facets of the type information may be specified at run-time and may lead to incompatible pin connections. In this case a run-time exception will be thrown.

### EXAMPLE

CPO A generates an image of type image/gif. CPO B can take an image of type image/gif and convert it to image/jpeg.
CPO B has the further restriction that it cannot deal with gif images that have been compressed using the LZW algorithm (for licensing reasons).
CPO A has a parameter that specifies whether or not the image it generates should be compressed or not, and what algorithm to use.

In the case that CPO A is connected to CPO B, it is not possible until run-time to determine if CPO B is type compatible with CPO A, since the exact type detail of the output pin of CPO A is determined by a run-time parameter.

In this case CPO A is allowed to connect to CPO B, but CPO B will generate a type incompatibility exception at run-time in the case that CPO A supplies an image that is LZW compressed.

Type Propagation

There are some situations in which the type of an output pin is dependent on the type of an input pin. FIG. 7 shows an operation 500 according to an embodiment of the present invention that has a single input pin 502 that accepts an input image and a single output pin 504 that generates a new image. The purpose of the operation 500 in this example is to add a border to an image.

In the example, the type of the input pin 502 is set to be mime/image to indicate that it can accept any image type. The output pin 504 is also typed as mime/image. In reality, we wish the type of the output pin 504 to be the same as the input pin 502.

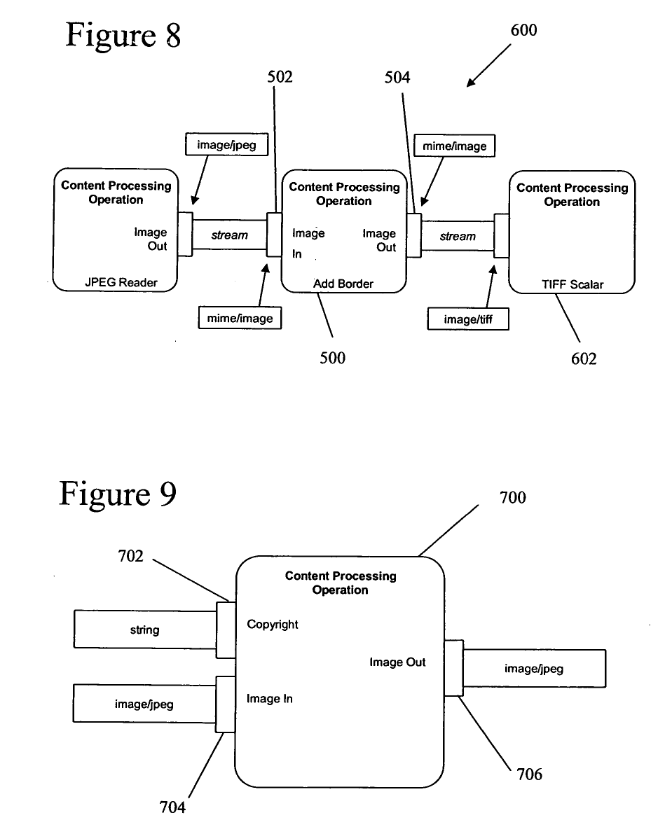

FIG. 8 shows the example content processing operation 500 of FIG. 7 connected into a simple workflow 600. The middle operation 500 is weakly typed as it does not define a specific, or variety of specific, types of image file that it accepts. The fact that a jpeg image is fed into the input pin 502 and fed out of the output pin 504 is not captured, thus it is possible to connect the output pin 504 to an operation 602 that can only handle tiff format images.

Type propagation is introduced in order to avoid this. This is a mechanism by which a content processing operation definition can describe the relationship between input and output pin types. The type of the output pin might be set to be exactly the same as the type of the input pin in a one-to-one relationship. Alternatively, an “n”-to-one relationship may exist where if the type of the input is one of “n” types, the type of the output may be set to an associated type.

The mechanism allows for an output pin to define that it propagates the type of an input pin, therefore the type of the output pin is not defined until the type of the input pin has been defined. An example definition of the content processing operation used in the examples above could be:

```
<?xml version=“1.0” encoding=“UTF-8”?>
<!-- Example CPO Definition -->
<Operation
  xmlns=“http://csf.hpl.hp.com/1/0/cpo/types/”
  xmlns:mime=“http://csf.hpl.hp.com/1/0/cpo/types/mime/”
  >
  <Identifier>http://csf.hpl.hp.com/1/0/cpo/image/addBorder</Identifier>
  <Description>Add a border to an image</Description>
  <Pins>
    <!-- Input Pin -->
    <Input>
      <Pin name=“Image In” optional=“False”>
        <Types>
          <Type priority=“1” type=“mime:image”/>
        </Types>
      </Pin>
    </Input>
    <!-- Output Pin -->
    <Output>
      <Pin name=“Image Out” propagates=“Image In”>
        <Types>
          <Type priority=“1” type=“mime:image”/>
        </Types>
      </Pin>
    </Output>
  </Pins>
</Operation>
```

Type propagation can be described by adding the “propagates” attribute to an output pin, for example as: <Pin name=“Image Out” propagates=“Image In”1>

Example Content Processing Operation Definition

FIG. 9 shows a Content Processing Operation 700 according to an embodiment of the present invention with two input pins 702, 704 and one output pin 706. The following XML document fragment shows how the pins and their types are represented:

```
<?xml version=“1.0” encoding=“UTF-8”?>
<!-- Example CPO Definition -->
<Operation
  xmlns=“http:csf.hpl.hp.com/1/0/cpo/types/”
  xmlns:image=“http://csf.hpl.hp.com/1/0/cpo/types/image/”
  xmlns:xsd=“http://www.w3.org/2001/XMLSchema”
  >
  <Identifier>http://csf.hpl.hp.com/1/0/cpo/image/textOverlay</Identifier>
  <Description>Overlays text onto an image</Description>
  <Pins>
    <!-- Input Pin -->
    <Input>
      <Pin name=“Copyright” optional=“False”>
        <Types>
          <Type priority=“1” type=“xs:string”/>
        </Types>
      </Pin>
      <Pin name=“Image In” optional=“False”>
        <Types>
          <Type priority=“1” type=“image:jpg”/>
        </Types>
      </Pin>
    </Input>
    <!-- Output Pin -->
    <Output>
      <Pin name=“Image Out” propagates=“Image In”>
        <Types>
          <Type priority=“1” type=“image:jpg”/>
        </Types>
      </Pin>
    </Output>
  </Pins>
</Operation>
```

Optional Pins

Input pins may be marked as optional. In this case they do not have to be connected to an output pin. Where an input pin is not marked as optional, it must be connected to a compatible output pin.

Output pins are always marked as optional, although for obvious reasons, not connecting at least one output of a content processing operation may not lead to a useful result.

Some optional pins may have a default value that they assume if they are not bound to. Other optional pins should not be bound to if other certain optional pins are bound to. That is, some optional pins may be mutually exclusive.

Event Pins

A content processing operation can generate events. A typical example would be events to indicate the progress that an operation is making. As an operation completes work it may wish to raise this as an event that a subscriber could use to provide feedback to a user or to another system component.

To facilitate this, the operation should be able to describe the set of events it can generate so that a consumer is aware of what notifications they can expect from the operation.

Events are modeled with event pins, just as inputs are modeled with input pins and outputs are modeled with output pins. Subscribing to an event produced by a content processing operation is modeled as connecting to the event pin of the content processing operation. Each event pin is effectively an event source that fires when an event occurs. Clients interested in receiving notification of events can subscribe to those sources and thus receive notifications.

As part of the Content Processing Abstraction, a base-line set of extensible events is defined to ensure consistency between operations. Examples of these base-line events are progress events and failure events. For example, a progress event could be produced at 10% of the way through processing the operation, 20% of the way through, 50% of the way through, etc. The progress of the operation could be displayed to a user, for example as a graph.

In some embodiments an event pin can trigger a further operation, for example based on event progress.

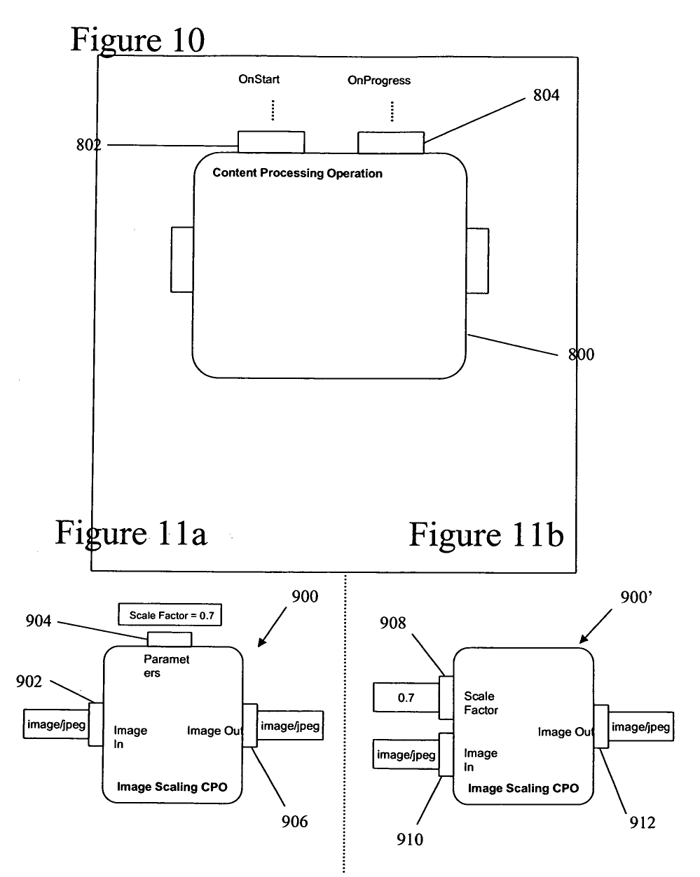

An example content processing operation 800 according to an embodiment of the present invention with event pins 802, 804 is illustrated in FIG. 10. Event pin 802 produces a signal when the operation 800 starts, and event pin 804 produces a signal at one or more predefined stages in the progress of the operation 800.

Event Pin Typing

As with input and output pins, event pins are typed. XML Schema can be used to define the types of event pins, effectively describing the structure of the message that will be sent to the receiver of the notification when the event is fired. Unlike input and output pins, event pins can only support a single type—the type of the event. The representation for event pin types is therefore slightly simpler than that for input and output pins, with the type being expressed using an attribute on the pin element in the definition, rather than as a separate type element.

An example of an event pin definition is shown below. The type of the pin is http://csf.hpl.hp.com/events#ProgressEvent.

```
<?xml version=“1.0” encoding=“UTF-8”?>
<!-- Event pin typing example -->
<Operation
  xmlns=“http://csf.hpl.hp.com/1/0/cpo/types/”
  xmlns:events=“http://csf.hpl.hp.com/1/0/cpo/types/events/”
  >
  <Pins>
    <Events>
      <Pin name=“OnProgress” type=“events:ProgressEvent”/>
    </Events>
  </Pins>
</Operation>
```

The XML Schema associated with the namespace is shown:

```
  <?xml version=“1.0” encoding=“UTF-8”?>
  <xs:schema xmlns:xs=“http://www.w3.org/2001/XMLSchema”
  elementFormDefault=“qualified”
  attributeFormDefault=“unqualified” targetNamespace=
  “http://csf.hpl.hp.com/events”>
  <xs:element name=“ProgressEvent”>
    <xs:annotation>
      <xs:documentation>Schema for ProgressEvent</xs:documentation>
    </xs:annotation>
    <xs:complexType>
      <xs:sequence>
        <xs:element name=“PercentageComplete” type=“xs:int”/>
      </xs:sequence>
    </xs:complexType>
  </xs:element>
<xs:schema>
```

An example XML document that conforms to the schema and represents an example of the message that would be emitted by the event pin when the event is raised is shown below:

<?xml version=“1.0” encoding=“UTF-8”?>
<ProgressEvent xmlns:xsi=“http://www.w3.org/2001/XMLSchema-
instance”>
<PercentageComplete>12</PercentageComplete>
</ProgressEvent>

Modeling Parameters

In defining a content processing operation, no differentiation is made between what may be thought of as inputs and parameters—these are both modeled as input pins. Consider for example a content processing operation that scales an input image to produce an output image. This could be modeled as an operation 900 according to an embodiment of the present invention as shown in FIG. 11a, with an input pin 92, an output pin 906 and a parameter 904 that defines the amount to scale the input image by.

Alternatively, and in some embodiments preferably, the operation 900′ is modeled as shown in FIG. 11b as having two input pins 908, 910 and a single output pin 912. Event pins are not shown.

In order that the number of input pins on a content processing operation is kept relatively small, developers may choose to model sets of parameters as a single parameter set and model this as a single input pin. This choice achieves the same outcome as that illustrated in FIG. 11a.

Schema for Operations

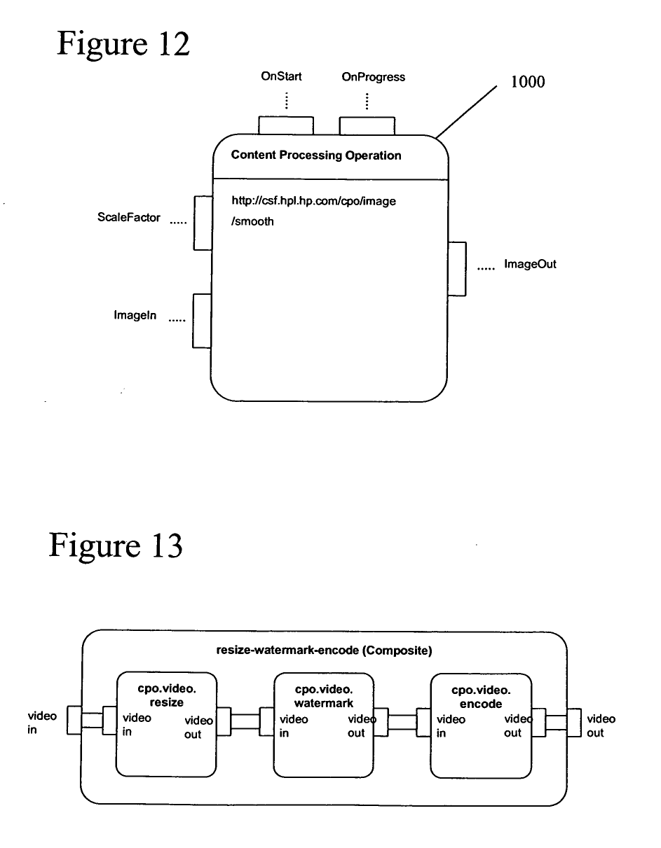

Operations are defined using XML. FIG. 12 shows a content processing operation 1000 according to an embodiment of the present invention. The corresponding definition expressed in XML is shown below:

```
<?xml version=“1.0” encoding=“UTF-8”?>
<!-- Example CPO Definition -->
<Operation
  xmlns=“http://csf.hpl.hp.com/1/0/cpo/types/”
  xmlns:cpo=“http://csf.hpl.hp.com/1/0/cpo/types/”
  xmlns:image=“http://csf.hpl.hp.com/1/0/cpo/types/image/”
  xmlns:events=“http://csf.hpl.hp.com/1/0/cpo/types/events/”
  >
  <Identifier>http://csf.hpl.hp.com/1/0/cpo/image/smooth</Identifier>
  <Description>Image Smooth Operation</Description>
  <Pins>
    <!-- Input Pins -->
    <Input>
      <Pin name=“SmoothFactor” optional=“True”>
        <Types>
          <Type priority=“1” type=“cpo:percentage”/>
        </Types>
      </Pin>
      <Pin name=“ImageIn” optional=“False”>
        <Types>
          <Type priority=“1” type=“image:dib”/>
          <Type priority=“2” type=“image:jpeg”/>
          <Type priority=“3” type=“image:gif”/>
          <Type priority=“4” type=“image:bmp”/>
        </Types>
      </Pin>
    </Input>
    <!-- Output Pins -->
    <Output>
      <Pin name=“ImageOut”>
        <Types>
          <Type priority=“1” type=“image:dib”/>
          <Type priority=“2” type=“image:tiff”/>
        <Types>
      </Pin>
    </Output>
    <!-- Events Pins -->
    <Events>
      <Pin name=“OnProgress” type=“events:ProgressEvent”/>
    </Events>
  </Pins>
</Operation>
```

Content Processing Operation Composites

The concept of a Content Processing Operation as an abstract definition for a primitive content processing operation, for example, image smoothing has been discussed.

Many prior art content processing components provide implementations of multiple content processing operations within the same component. In some cases these operations cannot be separated, in others they are linked together for performance reasons.

Consider the Telestream FlipFactory™ product as an example. This product can transcode video, taking in video streams in one format and generating video streams in different output formats such as Windows Media. Furthermore, it can overlay a watermark onto the video stream as it transcodes it. The product can be considered as an implementation of a video resizer, a video encoder and a video watermarker.

If FlipFactory were modeled as these three primitive operations, a video stream would have to be fed through the product three times to resize, encode and watermark a video. The advantage that FlipFactory can perform all three operations in one go would be lost.

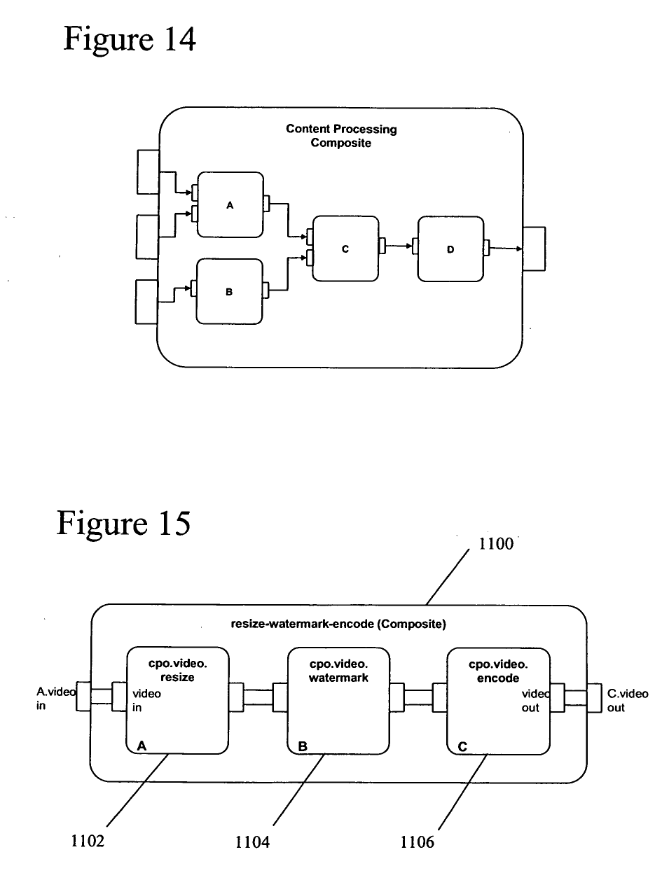

It is desirable to be able to express the ability to perform multiple primitives as one logical operation. In order to be able to do this, we introduce the concept of Composites. These are directed, acyclic graphs of primitive content processing operations. A simple example according to an embodiment of the present invention that reflects the FlipFactory scenario described previously is shown in FIG. 13 and a slightly more complicated example is shown in FIG. 14.

With this concept, third-party components that cannot be broken down into primitive operations can be modeled, and third-party components that give performance improvements when multiple operations are considered together can also be modeled.

Representation

FIG. 15 shows an example of a simple composite content processing operation 1100 according to an embodiment of the present invention that consists of three primitive content processing operations 1102, 1104, 1106 connected in a simple pipeline with the output of one feeding into the input of the next, as shown.

Each primitive operation inside the composite is given a unique label. In this case they have been labeled A, B and C. The unique labels ensure that instances can be differentiated, in the case that a composite contains more than one instance of the same primitive content processing operation.

The corresponding definition expressed in XML is shown below:

```
<?xml version=“1.0” encoding=“UTF-8”?>
<Composite name=“http://somecontainer.com/resize-watermark-encode”>
<!-- Primtive Operations in the composite -->
<Operations>
  <Operation name=
  “A”>http://csf.hpl.hp.com/1/0/cpo/video/resize</Operation>
  <Operation name=
  “B”>http://csf.hpl.hp.com/1/0/cpo/video/watermark</Operation>
  <Operation name=
  “C”>http://csf.hpl.hp.com/1/0/cpo/video/encode</Operation>
</Operations>
<Connections>
  <Connection from=“A.videoOut” to=“B.videoIn”/>
  <Connection from=“B.videoOut” to=“C.videoIn”/>
</Connections>
<Pins>
  <Pin name=“videoIn” alias=“A.videoIn”/>
  <Pin name=“videoOut” alias=“C.videoOut”/>
</Pins>
</Composite>
```

Each composite content processing operation has a unique identifier so that it can be differentiated from other composite content processing operations. As with primitive operations, the identifier may be a URI, for example: http://samplecontainer.com/composites/resize-watermark

Using Content Processing Operations

In outlining content processing operations (both primitive and composite) the key concepts were introduced, such as input and output pins, but no detail was provided about how to use content processing operations. Specifically, how input and output pins are connected (or bound) to data was not discussed. In this section we outline how a client (or application) works with content processing operations. In particular:
How to bind to a Content Processing Operation.
Mechanisms for binding pins to data.
The lifecycle of a content processing operation.

The abstract definition of a content processing operation according to an embodiment of the present invention has a concrete implementation that is provided by a content processing translator. Translators are discussed in detail later in this document, but it is necessary for the purposes of this section to introduce translators, since these are the sole interaction point when binding pins to data. Translators are concrete implementations that provide content processing operations.

Binding to a Content Processing Operation

From the external view of a translator, there is a single translator interface (or in some embodiments container interface) through which all interaction is performed. A content processing operation is an abstract definition.

In order to be able to invoke a content processing operation, one must first ask a translator to provide access to that operation. The translator is free to implement things as it sees fit. We therefore introduce the notion of a contract between the client and the translator. The client asks the translator for a contract for a given content processing operation. The translator can respond with a contract that the client can then use in further interactions with the translator.

In many ways this is analogous to a reservation or factory pattern. In returning a contract to the client, the translator is agreeing to provide the given content processing operation to the client.

The request that a client makes for a content processing operation is called a binding proposal. A minimal binding proposal contains the name of the content processing operation that is required by the client. The binding proposal consists of an XML document that requests the unique identifier associated with the required content processing operation. The binding proposal can request when and for how long they require access to the content processing component, and may also request a certain quality of the component, for example the operation should be capable of being performed in 2 seconds. In some embodiments the binding proposal can ask how long it will take the content processing component to perform the operation.

The response that a client receives back from a translator is called a binding offer. The binding offer also consists of an XML document and indicates whether or not the binding proposal was accepted and if so, under what conditions. Conditions might include the duration for which the offer is valid, and certain content types that it does not accept.

When a client accepts a binding offer, the content processing operation may be reserved for the client and the pins can connected to (or wired up) in stages or in parallel.

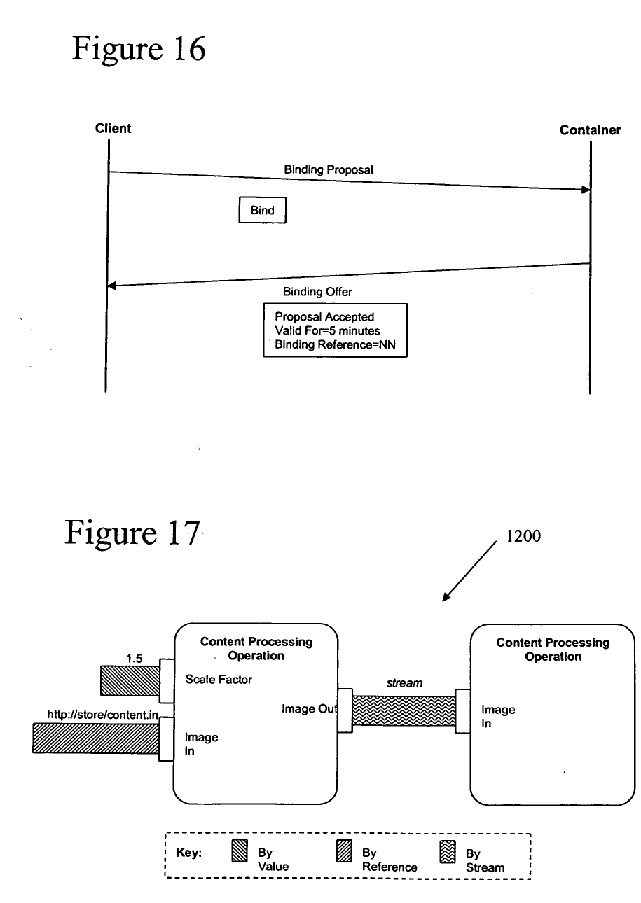

A typical simple example of binding to a content processing operation according to an embodiment of the present invention is illustrated in FIG. 16. It should be noted that this illustration uses an abstract notation; the actual notation is defined using XML schema and is discussed in detail later in the document. Also where reference is made to a container in the drawings, a container is the same as a translator.

Once a client obtains a contract, they are free to use the contract with the content processing operation for its period of validity or until they pro-actively release themselves from the contact.

When a translator returns a binding offer it provides a binding reference as part of the offer. The structure of the binding reference is private to the translator implementation, but must be included in future binding proposals that the client sends to the translator in relation to its original binding proposal. This provides the mechanism for a translator to relate subsequent binding messages to an initial binding message. The binding reference could be represented by a URI, or globally unique identifier or any other reference that can be represented as a string.

The contract and binding offers, proposals, and reference can be used for resource management of the content processing component, for example to load balance across a plurality of servers. Billing can also be performed by monitoring for how long a client reserves a content processing component, how may times the content processing operation is performed by the content processing operation and setting a cost per unit time that the client reserves the component, and a cost per time that the client performs the operation.

Resource management and billing can be advantageous in computer adaptive enterprises where customers buy time from other computers/servers, for example in a computer farm. Embodiments of the invention may be particularly advantageous for use with a video farm to enable all customers to access the farm in a standard way.

In some embodiments, a sophisticated resource management system can be used that can involve a broker to select an appropriate content processing component based upon a user's criteria for example, the time that the component is required, and a performance level associated with the component.

Binding Pins

Once a client has a contract with a translator to provide them with the services of a given content processing operation, they can connect to (or wire up) the pins of the operation. This wiring up is also referred to as binding.

There are three models for binding content to a pin:
By Value—The content is sent to/from the pin directly.
By Reference—A reference to the actual content is sent to the pin, rather than the content itself. The reference may be a URI that identifies the location of resolvable content. This may be an input or output pin from another operation.
By Stream—The pin is connected to an endpoint that streams the content. An input pin of one component may be connected to an output pin of another component by stream.

In the examples in this section we illustrate the binding of input and output pins and do not discuss event pins.

Note that by stream and by reference are similar. The key difference between these two models is that the translator must resolve the content reference into a by-stream reference.

An example of a content processing workflow 1200 according to an embodiment of the present invention that illustrates all three models is shown in FIG. 17.

To bind one or more pins the client sends a modified binding proposal to the translator. This proposal should contain proposed bindings for the pins that the client wishes to wire up. The translator will examine the proposed bindings and either accepts or rejects them and returns a binding offer to the client. Note that the example binding proposals discussed in the following sections are shown in an abstract notation. The actual notation is XML and is discussed later in the document.

Content by Value

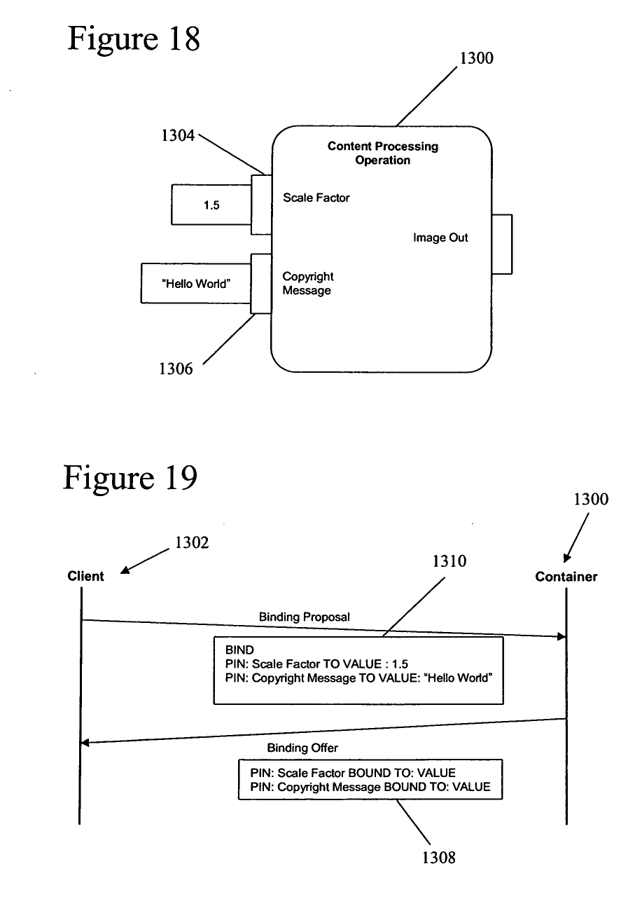

Content passed by value is directly supplied to the pin. This is typically how simple parameters are supplied to content processing operations. As an example, suppose a client wishes to bind the input pins 1304, 1306 of the content processing operation 1300 according to an embodiment of the present invention as shown in FIG. 18.

FIG. 19 shows schematically a valid binding conversation according to an embodiment of the present invention between the client 1302 and translator 1300 to bind the pins 1304, 1306 as illustrated in FIG. 18. Note once again that this is illustrated using an abstract notation and furthermore, the binding reference information that the translator 1300 will have provided as part of the initial binding to the operation process has also been omitted. This is true for all of the examples in this section of the document.

Note that when the translator 1300 returns a binding offer 1308, it indicates that the pins 1304, 1306 have been bound to the values supplied in the proposal 1310, but does not echo back to the client 1302 the value itself. This is deliberately done to avoid returning large binding offer messages when the values being supplied are themselves large (for example, a base-64 encoded thumbnail image).

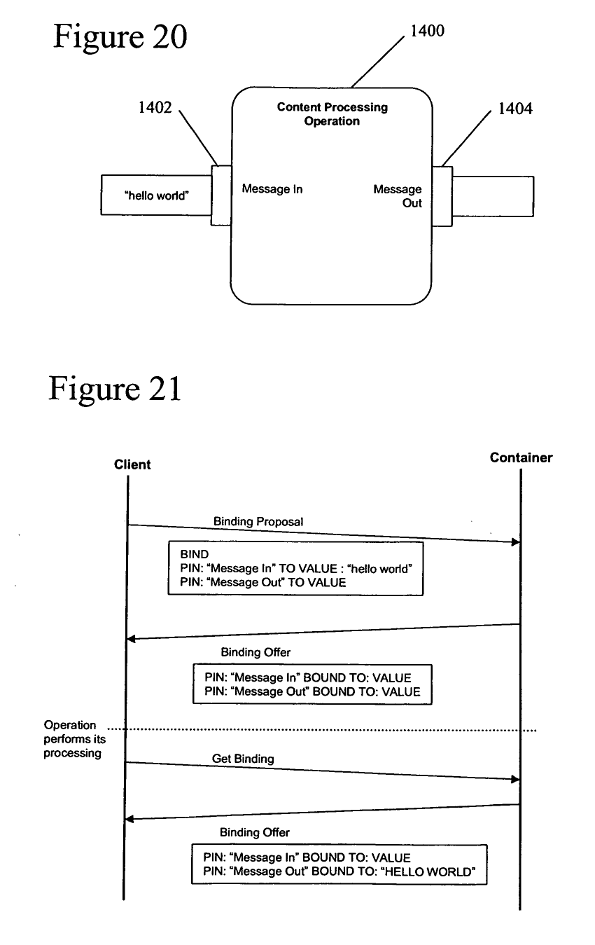

Although the example only illustrates binding input pins by value, output pins can also be bound by value. In this case the values of the output pins are made available through the binding offer. FIG. 20 shows a content processing operation 1400 according to an embodiment of the present invention that takes in content on a pin 1402 that is a string and outputs on an output pin 1404 the upper-case translation of the string. In this example we show both pins 1402, 1404 being bound by value.

The value of the output pin is not available until the operation 1400 has done its processing. An example binding exchange according to an embodiment of the present invention for this situation is illustrated in FIG. 21.

Content by Reference

Content passed by reference is done by passing a content identifier to the pin. The content processing translator must be capable of resolving the content identifier and must be able to support the protocol specified in the content identifier in order to be able to access the content. If a translator is not able to resolve the reference, or does not support the protocol associated with the content identifier, it must reject the binding proposal for that binding.

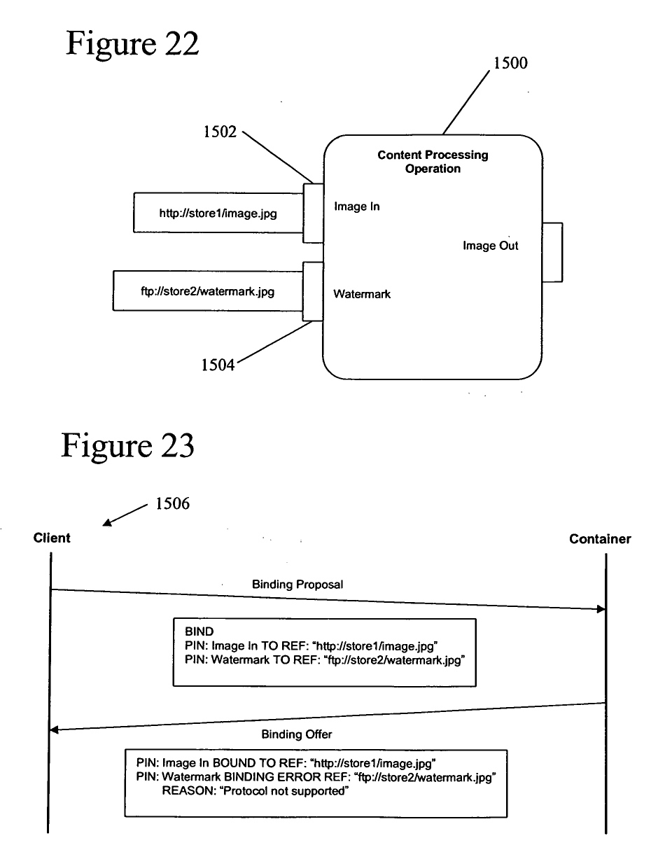

As an example, suppose a client wishes to bind the input pins of the content processing operation according to an embodiment of the present invention shown in FIG. 22. A valid binding conversation between the client 1506 and the translator 1500 might be as shown in FIG. 23.

In this example the binding proposal was only partially successful. The pin “Image In” 1502 was successfully bound to the content reference, but the pin “Watermark” 1504 could not be bound to its content reference because the translator 1500 does not support the ftp protocol.

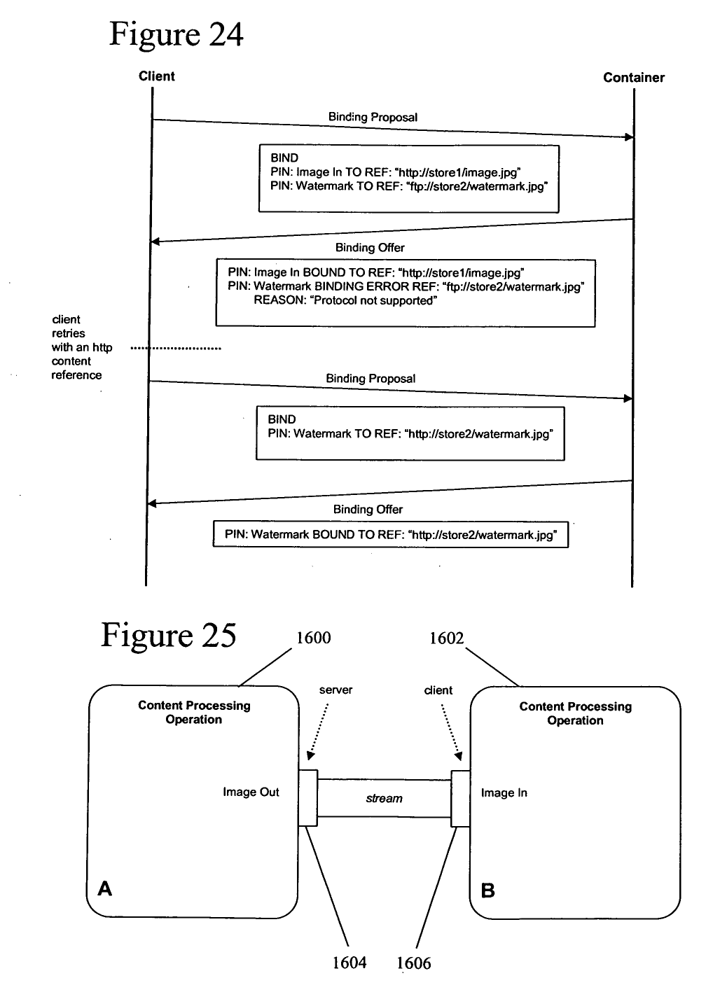

A client can submit multiple binding requests and in effect negotiate with a translator. If the example is extended so that the content for the watermark is available via either FTP or HTTP, then the client could detect the binding error on the watermark pin due to the ftp protocol not being supported and attempt to then bind the pin using the HTTP protocol. An example of the entire binding message exchange that could take place is shown in FIG. 24.

Content by Stream

When content is passed by stream, a connection must be established between the two endpoints. One of the endpoints will be the server and the other will be the client. The transport used for the stream must be supported by both endpoints. When content is passed by stream, the content will be streamed between two endpoints.

It is worth noting that the content by stream model is the most generic and can be used to wire pins to other pins or to any compatible transport endpoint.

When connecting an input pin and an output pin by stream, the client must choose one pin to be the client in the relationship and the other to be the server. The pin acting as the server will be responsible for establishing a stream endpoint to which the pin acting as the client can connect. Thus the connection is made from client to server and the pin acting as the server must therefore be bound before the pin acting as the client is bound.

When two pins are connected by stream, the pin that will act as the server will be presented with a weighted set of transports that the client supports. It must choose an appropriate transport and then instantiate a stream end point.

FIG. 25 shows an example of connecting together two content processing operations 1600, 1602 according to an embodiment of the present invention by stream.

In wiring up the content processing operation A 1600, we need to bind its output pin 1604 to be a server and then we will bind the input pin 1606 of content processing operation B 1602 to this server; content processing operation B 1602 will be the client in the relationship.

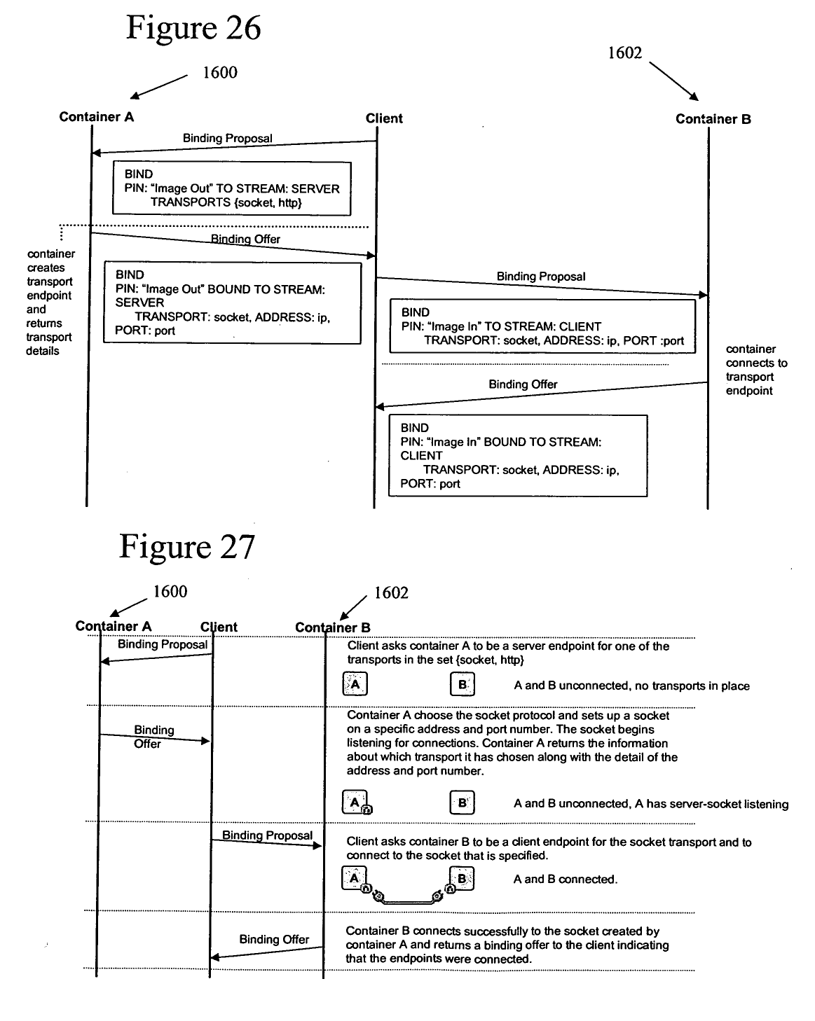

An example of the entire binding message exchange according to an embodiment of the present invention that could take place is shown schematically in FIG. 26 and in more detail schematically in FIG. 27.

Transport Selection when Connecting by Stream

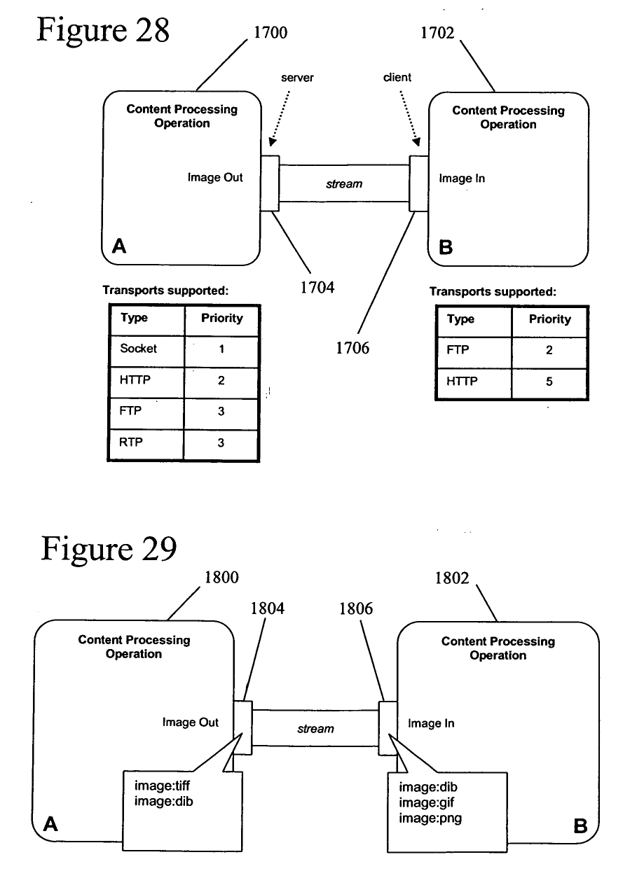

As can be seen in the examples in the previous sections, a translator can make the transport choice from a set of possible transports. FIG. 28 shows two content processing operations 1700, 1702 according to an embodiment of the present invention where both content processing operations 1700, 1702 support a plurality of transports.

In this example, translator A 1700 supports a number of transports, whilst translator B 1702 supports only the FTP and HTTP transports. When the two translators 1700, 1702 wish to connect the pins of content processing operations that they provide together, they must agree on a transport to use. Rather than negotiate through a series of conversations, the translators make available the set of transports that they support to the client. The client can pass in the set of supported transports into a binding offer, so that the translator that receives the binding offer can select an appropriate transport from the set passed in. As with types (as discussed earlier), a translator gives a priority to each transport that it supports to indicate its preference for that transport. Just as with types, these priorities (or weights) are non-negative integers, where a lower priority indicates more of a preference for a transport that a higher number.

In the example, if the client was binding translator B's 1700 “Image In” pin 1706 to translator A's 1700 “Image Out” pin 1704, it would ask translator A 1700 to set up an endpoint for translator B 1702 to connect to and would provide translator A 1700 with translator B's 1702 list of transports. In this example, this would be a list with the transports FTP and HTTP. Translator A 1700 would then compare this against its list and select the most appropriate. In this case it would be HTTP.

If the client were to perform the binding the other way around, it would ask translator B 1702 to set up an endpoint for translator A 1700 to connect to, and would provide translator B 1702 with translator A's 1700 list of transports. In this example, this would be a list with the transports: socket, HTTP, FTP and RTP.

Translator B would then compare this against its list and select the most appropriate. In this second case it would be FTP.

Type Selection when Connecting by Stream

Type selection occurs in exactly the same way as transport selection. A translator must make available the description of all types that it can accept on a given pin.

The binding examples used so far have deliberately omitted the type selection process.

FIG. 29 shows two content processing operations 1800, 1802 according to an embodiment of the present invention, each with a single pin that needs to be connected together. The callout box shows for each pin the types that it can handle. The example illustrates two translators, translator A 1800 and translator B 1802, that each provides a single content processing operation. The operation provided by translator A 1800 has an output pin named “Image Out” 1804 that can provide content in either the tiff or dib image types. Likewise, translator B 1802 provides an operation with an input pin named “Image In” 1806 that can consume content in either the dib, gif or png image types.

Clearly in this example, if it is desired to bind the “Image In” pin 1806 to the “Image Out” pin 1804, then the only compatible pin type is the dib image type. Type selection is the mechanism by which this choice is made.

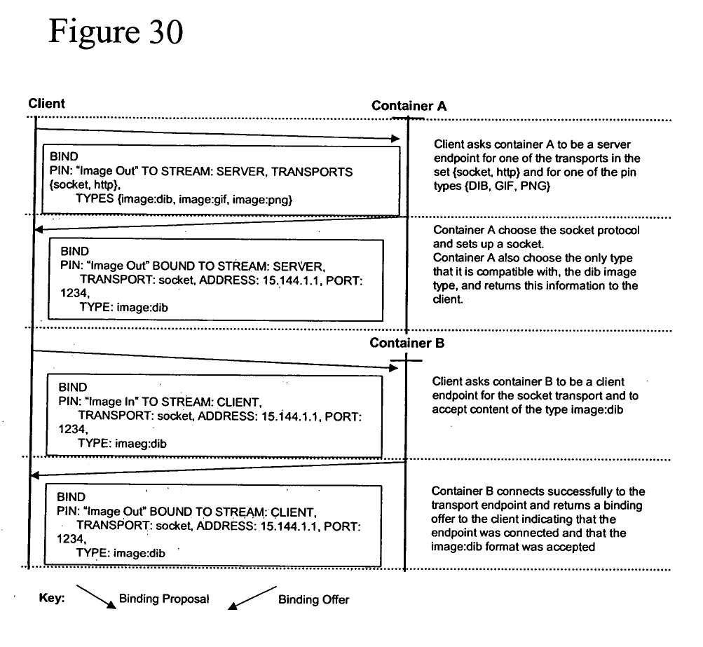

An example binding exchange according to an embodiment of the present invention that illustrates the type selection is illustrated in FIG. 30. It should be noted that this example uses an abstract notation for the binding offers and proposals.

Binding Intents

In the model presented so far, input and output pins can be bound using binding offer and proposal exchanges. A client can use multiple exchanges to progressively bind the pins of an operation, or could choose to bind all pins in one go.

The lifecycle of a content processing operation is discussed in detail later, and states in which a content processing operation will begin processing content as soon as its non-optional input pins are bound. This introduces a potential problem when a client wishes to bind pins in multiple stages—the operation may begin processing before some pins have been connected. In some embodiments, a default position is to begin processing when all of the mandatory pins have been set.

In order to solve this problem, the concept of binding intent is introduced. A binding intent allows a client to indicate in a binding offer that it intends to bind a pin at some stage during its exchanges. A content processing operation will not begin content processing until all of its non-optional pins and all of the pins that have a binding intent are bound.

FIG. 30 shows a single content processing operation 1900 according to an embodiment of the present invention with three pins that are to be bound. In this example the “Copyright Message” pin 1904 is optional and specifies a string to overlay on an image. If the “Image In” pin 1902 were bound before the “Copyright Message” pin 1904, then the content processing operation 1900 could begin processing, as all of its non-optional pins would have been bound. To avoid this, we use binding intent to inform the operation that we are going to bind the “Copyright message” pin 1904, and the “Image Out” pin 1906. The content processing operation 1900 only begins executing when all of the pins that are intended to be bound have been bound.

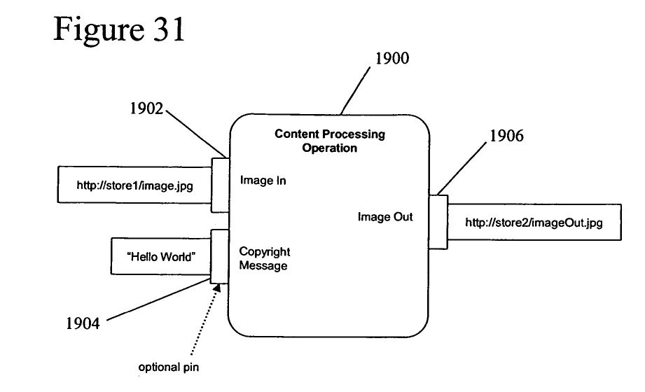

An example binding exchange according to an embodiment of the present invention is shown in FIG. 31. With this exchange, utilizing binding intents, processing will not start until all of the pins have been bound.

Binding Event Pins

As already described, event pins use exactly the same binding mechanism as input and output pins.

When an event is raised, the content processing operation will generate a message that represents the event and will send that message to the appropriate pin. The binding of the pin will determine how the message is then transmitted to the receiver.

Event pins use XML structured messages, defined using XML Schema.

Un-Binding Pins

A client may wish to un-bind pins that it has already bound. This is made possible by introducing the notion of a null binding.

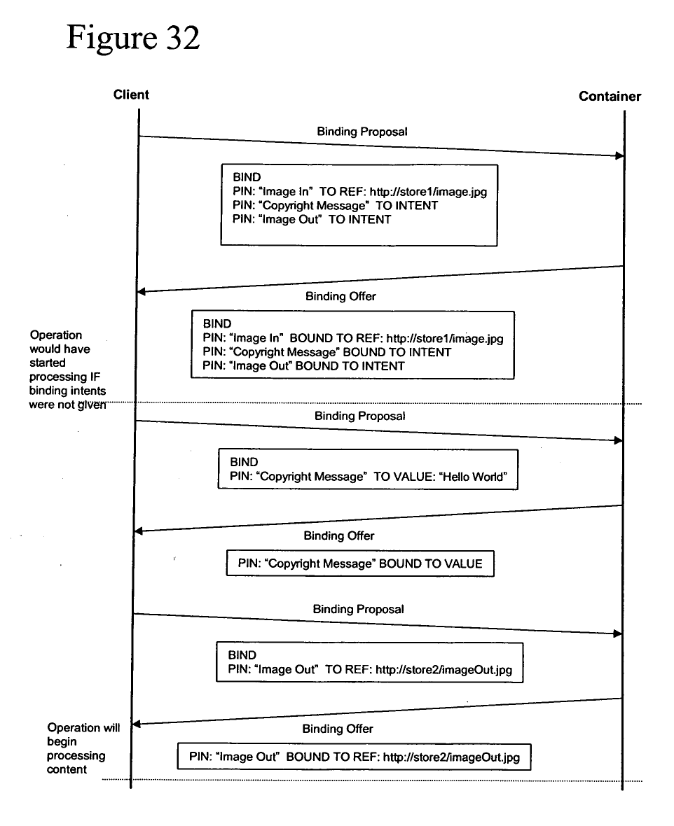

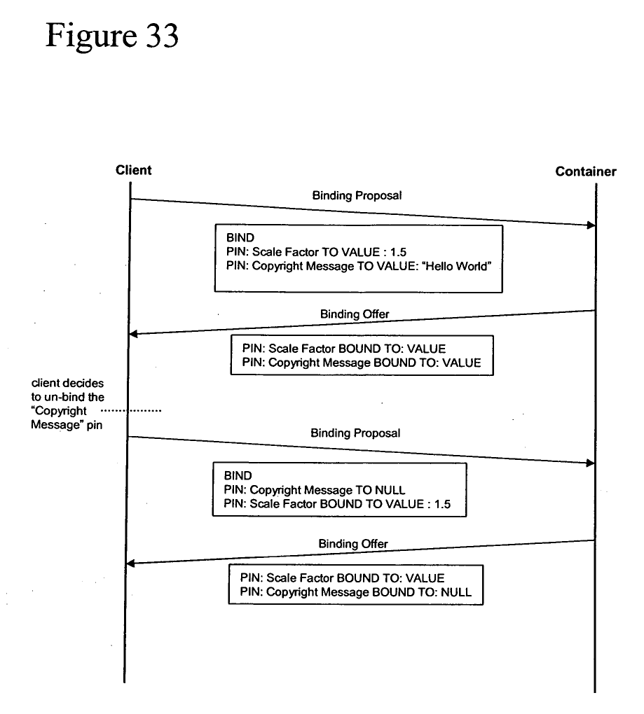

FIG. 32 illustrates a binding exchange according to an embodiment of the present invention for removing a binding from a pin. It should be noted that where a pin is bound multiple times, it is not possible to remove individual bindings; binding to null removes all bindings to a given pin.

Un-Binding from a Content Processing Operation

When a client has finished with a contract that it has obtained from a translator, it can release it's binding to that contract so that the translator can reclaim those resources for another client. Where specified, contracts will expire after a given time period, and in some embodiments a client can use the translator as many times as they want, possibly with different content, within this time period. In some embodiments, using the translator a number of times under the same contract may help lower the costs associated with reserving the content processing component whilst still performing operations on different content.

Clients are encouraged to pro-actively release bindings when they no longer require them so that resources are not tied-up unnecessarily.

Releasing a binding is achieved by passing the binding into the translator and asking it to release that binding.

Content Processing Operation Lifecycle

In the previous parts of this section the binding concepts and the notion that a binding offer has a period of validity has been introduced, but there has been no discussion of the detailed lifecycle of content processing operations, and in particular, a discussion of what happens when a content processing operation actually begins processing content.

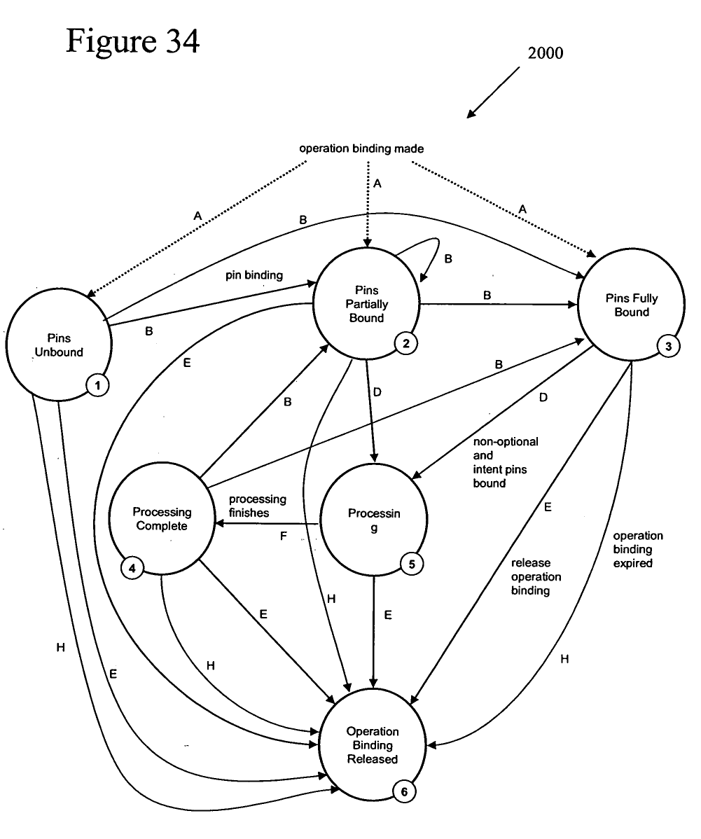

FIG. 34 shows a state machine 2000 according to an embodiment of the present invention, the state machine 2000 shows the lifecycle for content processing operations.

A client first obtains a binding to a content processing operation by submitting a binding proposal to its translator. As well as specifying a binding to an operation, the proposal can also contain binding information for pins. The binding proposal could specify no pin bindings, some bindings for the pins, or bindings for all of the pins. This is captured in the diagram by the transitions labeled A, that lead to either states 1, 2, 3 (Pins Unbound, Pins Partially Bound and Pins Fully Bound, respectively).

In the “Pins unbound” state, a subsequent binding proposal can lead to either the “Pins Partially Bound” or “Pins Fully Bound” states, depending on the completeness of the binding proposal (shown as transitions labeled B).

In the “Pins Partially Bound” state, a subsequent binding proposal can lead either back to the “Pins Partially Bound” or “Pins Fully Bound” states, depending on the completeness of the binding proposal (shown as transitions labeled B).

In both the “Pins Fully Bound” state and the “Pins Partially Bound” state, a transition to “Processing” can occur if the non-optional pins and those pins marked with a binding intent have all been bound. This is the trigger that causes an operation to being processing and causes it to enter the “Processing” state.

In the “Processing” state, upon completion of processing, a transition occurs to the “Processing Complete” state (transition labeled F). Also in this state, a “release binding” message will effectively attempt to abort the processing and thus cause a transition to state number 6 (Operation Binding Released).

In the state “Processing Complete”, transitions back to either of the states “Pins Partially Bound” and “Pins Fully Bound” are possible (labeled B) by rebinding the pins of the operation. This can be used, for example, to reuse an operation for processing multiple pieces of content; the operation can have its pins bound once, perform a single content processing operation, have one or more pins rebound and then process again, according to the new binding arrangement.

In all states (other than the “Operation Binding Released” (number 6)), a client can release the operation binding, resulting in transitions to the state “Operation Binding Released” through the transition labeled E. Once an operation binding has been released it cannot be reused by a client.

In all states (other than “Processing”), the operation binding may expire, in which case the transition labeled H occurs leading to the “Operation Binding Released” state.

Content Processing Translators

A Content Processing Translator, also referred to as a container, implements abstract content processing operations and provides an interface for applications to be able to work with the content processing operations that it provides.

Whereas content processing operations are abstract definitions, the translator is a concrete implementation that effectively implements the content processing operations and provides other supporting logic to make the translator usable by applications.

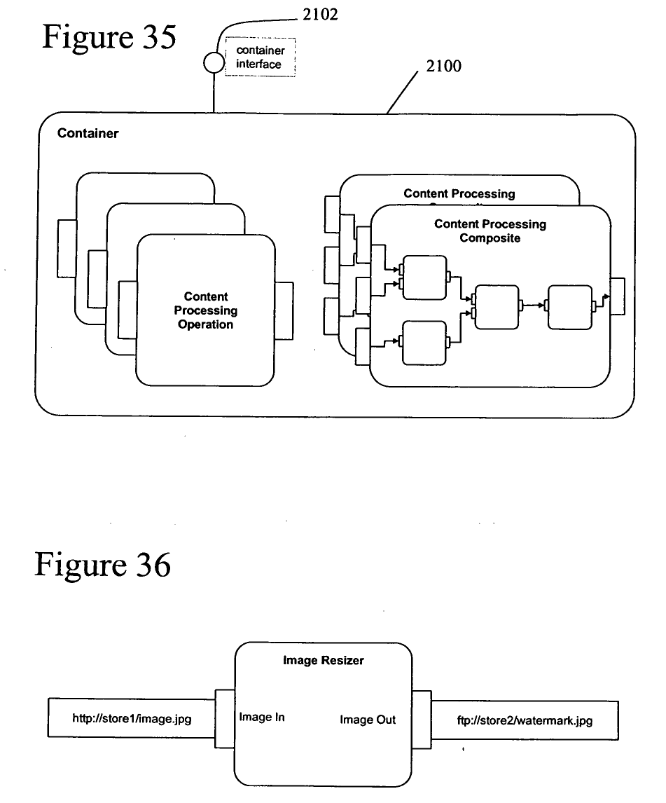

A translator 2100 according to an embodiment of the present invention is shown pictorially in FIG. 35.

The key concepts to note are:
A translator provides the implementation of both primitive and composite operations.
A translator provides a single interface through which all communication is routed.
The implementation of a translator is completely hidden from the client; a translator author must only ensure that they implement the translator interface.
   Translator Responsibilities

A translator can undertake some or all of the following responsibilities:
To provide access to the translator capabilities. The translator provides mechanisms to discover the set of primitive and composite content processing operations that it implements.
To provide a mechanism for binding to a content processing operation.
To provide a mechanism for binding the pins of a content processing operation.
To release bindings.
To enumerate the content protocols that a translator supports.

All of these responsibilities are exposed through the translator interface 2102 in FIG. 35. A translator undertakes these responsibilities by implementing the translator interface and adhering to the binding protocol/binding mechanism/interaction model.

The sub-sections that follow provide detail on each of the main translator responsibilities.

Translator Capabilities

In order to be able to use a translator, a client will need to know which primitive and composite content processing operations a translator supports. In order to do this, a translator provides a mechanism to obtain this information.

The translator reports primitive and composite operations separately so that simple clients can utilize the primitive operations very easily without having to understand a graph language that can be used to describe composite operations. More advanced clients can take advantage of the composite information to enhance their use of translators.

Binding to Operations

Once a client has established that a translator supports a content processing operation of interest, it must be able to request that a translator provides it with access to that operation. This is done by binding to the operation. A client submits a binding proposal to the translator, which specifies which operation it requires along with other specific binding information.

In binding to an operation, the translator effectively agrees to enter into a contract with the client to provide the specified content processing operation. Once a translator has agreed to a binding, it must be able to provide the given operation to the client. A translator can reject a binding proposal if it is unable to meet the demands of the proposal.

When a translator agrees to a binding proposal, it returns a binding offer to the client. This binding offer may only be valid for a given period of time after which it may expire. This information is included in the offer. If a client wishes to reject the offer or no longer requires the operation, it should release the binding offer.

An example of a binding proposal is shown below:

```
<?xml version=“1.0” encoding=“UTF-8”?>
<!-- Example binding document-->
<Binding binding=“proposal”>
  <Operation>
    <Name>http://csf.hpl.hp.com/1/0/cpo//image/smooth</Name>
  </Operation>
</Binding>
```

A corresponding binding offer might be:

```
<?xml version=“1.0” encoding=“UTF-8”?>
<!-- Example binding document - Offer -->
<Binding binding=“offer” validity=“00:00:05” status=“accepted”>
  <Operation>
  <Name>http://csf.hpl.hp.com/1/0/cpo/image/smooth</Name>
  <Reference>97da-1244-1232-3453452343</Reference>
  </Operation>
</Binding>
```

This offer illustrates a successful binding offer-proposal exchange. Note that the translator returns binding reference information as part of the binding proposal in order to correlate subsequent binding offers with the first operation binding. The details of the binding reference are left entirely to the translator. The reference could be a URI, a GUID (Globally Unique Identifier as shown in the example above) or any other information. An example illustrating a URI binding reference is shown below:

```
<?xml version=“1.0” encoding=“UTF-8”?>
<!-- Example binding document . Offer, -->
<!.Binding Reference is a URI-->
<Binding binding=“offer” validity=“00:00:05” status=“accepted”>
  <Operation>
  <Name>http://csf.hpl.hp.com/1/0/cpo/image/smooth</Name>
  <Reference>http://somecontainer/op/id</Reference>
  </Operation>
</Binding>
```

The example below shows an unsuccessful binding offer in response to the same binding proposal.

```
<?xml version=“1.0” encoding=“UTF-8”?>
<!-- Example binding document - Offer -->
<!-- Binding rejected -->
<Binding binding=“offer” status=“rejected”>
  <Operation>
  <Name>http://csf.hpl.hp.com/1/0/cpo/image/smooth</Name>
  </Operation>
  <BindingError>
  <Name>NoSuchOperation</Name>
  <Description>The requested media processing operation is not
  supported by the container</Description>
  </BindingError>
</Binding>
```

Note that because the binding offer was rejected, the translator did not insert binding reference information, because no binding was made. When a binding offer is rejected, the translator must return error information to allow the client to understand why the binding was not accepted.

Typical errors that may occur when attempting to bind to an operation are:
NoSuchOperation—The client is asking for an operation that is not supported by the translator.
ContainerTooBusy—The translator does not have any free resources to supply the operation to the client.
   Binding Operation Pins

Once a client has bound to an operation it can send requests to the translator to bind the pins of the content processing operation. This is achieved by modifying the binding offer received from a translator and passing it back to the translator through an UpdateBinding method as a new binding proposal.

FIG. 36 shows a pin-binding example according to an embodiment of the present invention.

Before attempting to bind the pins of the operation, the client will have obtained a binding offer from the translator. An example of the binding offer that would be returned is shown below:

```
<?xml version=“1.0” encoding=“UTF-8”?>
<!-- Example binding document - Offer -->
<Binding binding=“offer” validity=“00:05:00” status=“accepted”>
  <Operation>
  <Name>http://csf.hpl.hp.com/1/0/cpo/image/resize</Name>
  <Reference>97da-1244-1232-3453452343</Reference>
  </Operation>
</Binding>
```

The client can modify this offer back into a proposal and ask the translator to update the binding. The example binding proposal shown below illustrates an attempt by a client to bind both pins as shown in FIG. 36.

```
<?xml version=“1.0” encoding=“UTF-8”?>
<!-- Example binding document - Proposal -->
<Binding binding=“proposal”>
  <Operation>
  <Name>http://csf.hpl.hp.com/1/0/cpo/image/resize</Name>
  <Reference>97da-1244-1232-3453452343</Reference>
  </Operation>
  <Pins>
  <Pin name=“Image In”>
    <Binding method=“ByRef”>
    <Reference>http://store1/image.jpg</Reference>
    </Binding>
  </Pin>
  <Pin name=“Image Out”>
    <Binding method=“ByRef”>
    <Reference>ftp://store2/watermark.jpg</Reference>
    </Binding>
  </Pin>
  </Pins>
</Binding>
```

The example binding proposal shows that for each pin that the client wishes to bind, it supplies the binding information for the binding it requires. In this simple example only the binding to content references are shown—other binding examples will illustrate binding by value and by stream.

Having constructed the binding proposal, this is then sent to the translator using the UpdateBinding method. The translator responds with a binding offer. An example response for the offer shown above is shown below.

```
<?xml version=“1.0” encoding=“UTF-8”?>
<!-- Example binding document - Offer -->
<Binding type=“offer” validity=“00:05:00” status=“partial”>
  <Operation>
  <Name>http://csf.hpl.hp.com/1/0/cpo/image/resize</Name>
  <Reference>97da-1244-1232-3453452343</Reference>
  </Operation>
  <Pins>
  <Pin name=“Image In”>
    <Binding method=“ByRef” status=“accepted”>
    <Reference>http://store1/image.jpg</Reference>
    </Binding>
  </Pin>
  <Pin name=“Image Out”>
    <Binding method=“ByRef” status=“rejected”>
    <Reference>ftp://store2/watermark.jpg</Reference>
    </Binding>
    <Error>
    <Name>ProtocolNotSupported</Name>
    <Description>Container does not support the protocol specified
    in the reference</Description>
    </Error>
  </Pin>
  </Pins>
</Binding>
```

In this example, the translator does not support the ftp protocol and so returns a binding offer that is only a partial acceptance of the submitted binding offer. This partial acceptance is indicated at the top-level of the binding offer to easily allow clients to determine if their proposal was accepted in full, in part, or not at all. The binding of the pin named “Image In” was successful, and this is reflected in the binding for that pin as being marked “accepted”. The binding of the pin “Image Out”, however, was not successful, and is thus marked as being rejected. The translator adds binding error information to the pin to allow the client to quickly determine why the binding offer was unsuccessful.

Releasing Bindings

When a translator returns a binding offer to a client, the period of validity of the offer is indicated in the offer. If a client no longer needs to use the offer that it has had from a translator, then it should release the binding so that the translator can re-use resources that it might have committed to the offer. Early releasing of bindings is encouraged.

When a client releases a binding, all of the pin bindings will be released along with the operation binding. The RelaseBinding method will effectively disconnect all of the operation pins that are still bound and then release the operation binding.

As with submitting binding offers, requesting that a binding is released can be rejected by a translator. In this case, the translator will return a binding offer that indicates that the binding could not be released. In the case that binding is released successfully, the translator returns a binding document to indicate such. An example of this case is shown below:

```
<?xml version=“1.0” encoding=“UTF-8”?>
<!-- Example binding document - Offer -->
<Binding type=“offer” status=“released”>
  <Operation>
  <Name>http://csf.hpl.hp.com/1/0/cpo/image/resize</Name>
  </Operation>
</Binding>
```

Binding State

The discussion in relation to FIG. 34 we introduced the lifecycle for a content processing operation and the states that a binding may exist in were shown.

A client may wish to retrieve the state of a given binding, so that it can determine if processing has started, or indeed, if processing has completed.

State information is included in the binding document within the operation section. A client can request the state from the translator using the binding reference. An example return message is shown below:

```
<?xml version=“1.0” encoding=“UTF-8”?>
<!-- Example binding document showing state information-->
<Binding type=“offer” validity=“00:05:00” >
  <Operation>
  <Name>http://csf.hpl.hp.com/1/0/cpo/image/resize</Name>
  <Reference>97da-1244-1232-3453452343</Reference>
  <State>Processing</State>
  </Operation>
</Binding>
```

Binding Manager

In some embodiments a binding manager is provided to enable binding contracts to be created. The binding manager provides a user with access to binding protocols, which enable a user to reserve operations, create binding proposals, respond to binding offers, wire up pins and enables any other functionality that involves a user interacting with a translator/container according to an embodiment of the present invention. The binding manager may be a standard component that each user of content processing components according to embodiments of the present invention has access to.

Translator Interface

A translator provides a single interface/container that can provide one, some, or all of the following methods:
GetOperations—Returns the set of primitive content processing operations supported by the translator.
GetComposites—Returns the set of composite content processing operations supported by the translator.
RequestOperationBinding—Binds to a primitive or composite content processing operation.
UpdateBinding—Binds the pins of a content processing operation.
InvokeOperation—Invokes a primitive or composite operation in a synchronous manner.
ReleaseBinding—Releases a binding to a primitive or composite content processing operation.
GetBinding—Returns binding information for a given binding.
GetProtocols—Returns the set of protocols supported by this translator (for communicating with content references).

In some embodiments all of the above methods are required to provide a usable translator interface/container. The methods are not native to the content processing components that they interface with. Although in some embodiments the non-native interface may be the same as the in-built interface of the content processing operation.

It is this functionality that provides the non-native interface according to embodiments of the present invention. The container interface, or translator interface, provides the key functionality that is consistent with all content processing operations and components according to embodiments of the present invention. The consistency of the functionality of the translator interface provides greater interoperability/access across a plurality of content processing components according to embodiments of the present invention.

GetOperations

The GetOperations method returns a list of the primitive content processing operations that the translator supports. The information is returned as an XML document containing the list of the identifiers of the supported operations. A client can use this information to determine if a translator provides operations that it might require.

Syntax:

GetOperations(OUT SupportedPrimitives)

This method takes no parameters and returns an XML document that describes the set of supported operations. An example of the XML returned by this method is shown below:

```
<?xml version=“1.0” encoding=“UTF-8”?>
<!-- Example documenr returned by the GetOperations method-->
<Operations>
  <Operation>http://csf.hpl.hp.com/1/0/cpo/image/smooth</Operation>
  <Operation>http://csf.hpl.hp.com/1/0/cpo/image/resize</Operation>
  <Operation>http://csf.hpl.hp.com/1/0/cpo/image/sharpen</Operation>
</Operations>
```

GetComposites

The GetComposites method returns a list of the composite content processing operations that the translator supports. Each composite operation is a graph, so the returned list is a set of graphs. A client can use this information to take advantage of translators that efficiently implement composite operations.

Syntax:

GetComposites(OUT SupportedComposites)

This method takes no parameters and returns an XML document that describes the supported composite operations. An example of the XML that is returned by this method is shown below:

```
<?xml version=“1.0” encoding=“UTF-8”?>
<!-- Example document returned by GetComposites method -->
<Composites>
  <Composite name=“http://somecontainer.com/resize-watermark-
  encode”>
  <Operations>
    <Operation name=“A”>http://csf.hpl.hp.com/1/0/cpo/video/
    resize</Operation>
    <Operation name=“B”>http://csf.hpl.hp.com/1/0/cpo/video/
    watermark</Operation>
    <Operation name=“C”>http://csf.hpl.hp.com/1/0/cpo/video/
    encode</Operation>
  </Operations>
  <Connections>
    <Connection from=“A.videoOut” to=“B.videoIn”/>
    <Connection from=“B.videoOut” to=“C.videoIn”/>
  </Connections>
  <Pins>
    <Pin name=“videoIn” alias=“A.videoIn”/>
    <Pin name=“videoOut” alias=“C.videoOut”/>
  </Pins>
  </Composite>
  <Composite name=“http://somecontainer.com/resize-watermark”>
  <Operations>
    <Operation name=“A”>http://csf.hpl.hp.com/1/0/cpo/video/
    resize</Operation>
    <Operation name=“B”>http://csf.hpl.hp.com/1/0/cpo/video/
    watermark</Operation>
  </Operations>
  <Connections>
    <Connection from=“A.videoOut” to=“B.videoIn”/>
  </Connections>
  <Pins>
    <Pin name=“videoIn” alias=“A.videoIn”/>
    <Pin name=“videoOut” alias=“B.videoOut”/>
  </Pins>
  </Composite>
</Composites>
```

RequestOperationBinding

The RequestOperationBinding allows a client to bind to a primitive or composite Content Processing Operation. This will bind to the given content processing operation, if this is possible, otherwise an error is returned.

Binding to an operation is analogous to reservation. From the external caller's point of view, what happens inside the translator is irrelevant. The translator must return a binding that is for the exclusive use of the method caller.

If the operation is bound successfully, the translator should pass the supplied binding information to the UpdateBinding method of the translator. This effectively allows pin binding to be performed as part of the binding to the operation.

Syntax:

RequestOperationBinding(IN BindingProposal, OUT BindingOffer)
   UpdateBinding

The UpdateBinding method allows a client to modify a binding to an operation. This is the mechanism by which clients can bind pins. This method takes in a binding proposal and returns a binding offer. The binding offer that is passed in must relate to a binding offer already obtained through a call to RequestOperationBinding.

Syntax:

UpdateBinding(IN BindingProposal, OUT BindingOffer)
   InvokeOperation

The InvokeOperation method invokes an operation or composite in a synchronous manner.

Syntax:

InvokeOperation(IN BindingProposal, OUT BindingOffer)
   ReleaseBinding

The release binding method releases a binding that a client has obtained from a translator. The input to the method must be the binding offer that the client has obtained from the translator. The translator will return an updated binding offer that indicates whether or not the binding was released successfully.

Syntax:

ReleaseBinding(IN BindingProposal, OUT BindingOffer)
   GetBinding

Returns the binding.

Syntax:

GetBinding(IN BindingReference, OUT BindingInstance)
   GetProtocols

The GetProtocols method returns the list of protocols that a translator supports for handling content references. A content reference is made up of a protocol part and an identifier part. This method returns an ordered list of supported protocols. Each entry in the returned list has an associated priority, which indicates the translator's preference for that protocol. A low priority signifies a more preferred protocol. Where a translator does not care about expressing a preference over priorities it may use the same priority for those protocols.

Syntax:

GetProtocols(OUT SupportedProtocols)

An example of the XML that is returned by a call to GetProtocols is shown below. In this example the translator expresses that it supports the HTTP, FTP and RTP protocols and that it is equally happy to use HTTP and FTP but less happy to use RTP than either of those.

<?xml version=“1.0” encoding=“UTF-8”?>
<!-- Example document returned by the GetProtocols method-->
<Protocols>

<Protocol priority=“1”>HTTP</Protocol>
<Protocol priority=“1”>FTP</Protocol>
<Protocol priority=“2”>RTP</Protocol>

</Protocols>

The client will typically use this information to ensure that a translator can handle a content reference that it might wish to bind to a pin in the translator before attempting the binding.

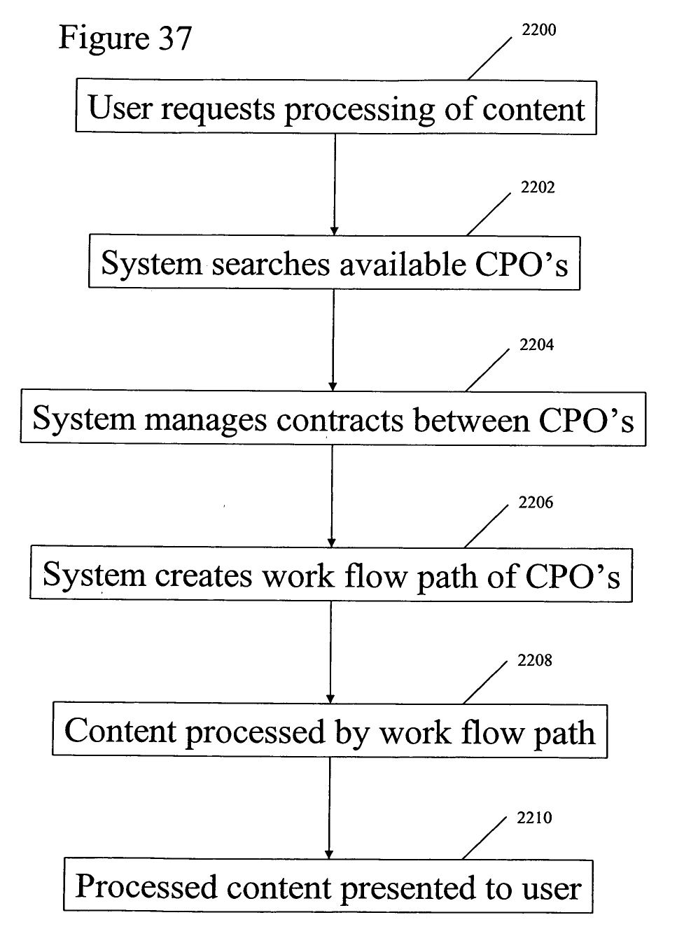

FIG. 37 shows a flow chart of steps that are carried out when performing a method according to an embodiment of the present invention. At step 2200 a user requests a content processing operation, or combination of content processing operations, to be performed on a specific piece of content that he provides. In some embodiments, instead of providing the content to the system himself, the user may indicate the location in memory, or any other identifier of the content to be processed, to enable the system to retrieve the piece of content.

In other embodiments the user may not have any content ready for processing: they may instead be setting up the capability to perform a particular CPO, ready for the time that it is needed.

At step 2202, a system that uses a model according to an embodiment of the present invention automatically searches the CPOs that are available to it. This may involve searching a local memory within a single computer for CPOs, searching the memory of a remote device over a network, and/or consulting a library/database that contains information on which CPOs are available and where they are stored. Remote devices may be connected over a local area network, metropolitan area network, a wide area, distributed, network, or the Internet, for example.

In some embodiments the system may broadcast a request for provision of services to devices over a network, and any devices that respond to the request identifying themselves as capable of satisfying the desired requirements can be managed by the system in order to select the most appropriate device to provide the CPO. The most appropriate CPO may be the CPO that can provide the operation quickly, cheaply, using the least bandwidth, or otherwise in an efficient way.

In some embodiments the system will search for a complex CPO that provides all of the functionality that the user has requested. If a complex CPO that provides all of the desired functionality is not found, then the system searches for other complex CPOs that can be linked together to provide the overall desired functionality. If no complex CPOs are found, or some complex CPOs are found that only provide part of the overall desired functionality, the system will look for primitive/atomic CPOs that provide the remaining functionality.

In some embodiments, the step of searching for available CPOs may involve copying and migrating appropriate software from existing memory, for example from synthesized work flow paths. This may involve copying and migrating software from first, second (and third and fourth if necessary) CPOs and getting them to reside close together on the system, so that they can operate more efficiently in the future—thereby creating an “easy”, more efficient in terms of network resources, new CPO.

If no combinations of CPOs that can provide the desired functionality are found, then an error message is reported to the user, and the method terminates without processing the content.

At step 2204, the system manages contracts between the CPOs that have been found at step 2202, as discussed above. A work flow path of CPOs is created from the CPOs that the system has successfully managed contracts between at step 2206. The work flow path of CPOs provides the overall content processing functionality as requested by the user at step 2200.

At step 2208 the content that was supplied by the user at step 2200 is processed by the work flow path of CPOs, and the processed content is presented to the user at step 2210.

All the user experiences during the operation of this method according to an embodiment of the invention, is that he enters a request for some data/content to be operated upon and then he receives the processed data from the system. All of the searching, negotiating contracts, linking together CPOs etc. is performed by the system “beneath the surface”, and is not visible to the user.

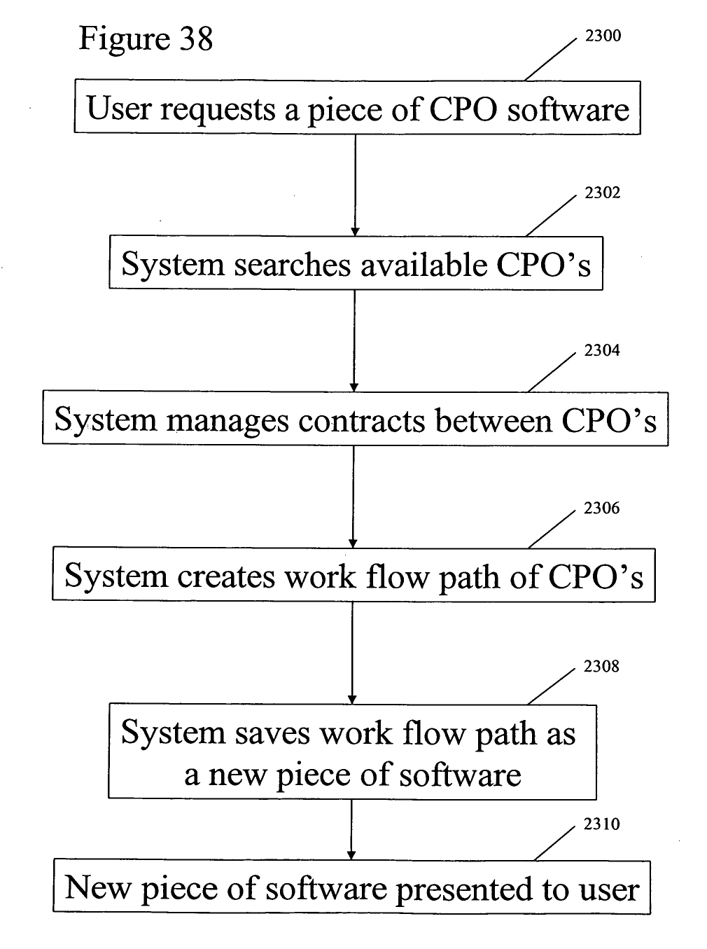

FIG. 38 shows a flow chart of steps that are carried out when performing a method according to an embodiment of the present invention. At step 2300 a user requests a piece of software to be generated that provides a content processing operation, or combination of content processing operations.

The user may require their own copy of software that provides the desired content processing operation so that they can use the software on any content when they want to.

In some embodiments, the user may be a software developer who provides content processing solutions to their clients. Embodiments of the present invention can be used by the software developer to more quickly, easily, cheaply and efficiently provide solutions to their clients.

At step 2302, a system that uses a model according to an embodiment of the present invention automatically searches the CPOs that are available to it in the same way as discussed with relation to step 2202 in FIG. 37.

The system then manages contracts between CPOs at step 2304 and links them together to create a work flow path at step 2306 in the same way as discussed with relation to steps 2204 and 2206 of FIG. 37.

At step 2308, the system saves the created work flow path as a new piece of software and presents the new piece of software to the user at step 2310. The user can then save the software into his own directory for use later.

All the user experiences when the method shown in FIG. 38 is performed is that he enters a request for some software that can perform a desired content processing operation, and the software that has been requested is presented to him. All of the searching, negotiating contracts, linking together CPOs etc. is performed by the system “beneath the surface”, and is not visible to the user.

In other embodiments, a software development company may provide their client with access to models, systems and methods according to embodiments of the present invention so that the client can create their own content processing work flow paths. The client can create/perform complex content processing operations, or develop complex content processing software, without requiring the expertise to develop bespoke pieces of software to link together existing CPOs. The software development company may provide access to embodiments of the present invention for a flat fee, or for a set amount per content processing work flow created, or for any other remuneration, or on any other basis.

1. A computer processor and associated computer memory which has in the memory a number of existing content processing operations (CPOs) which include associated description of the type of content they can process, and which has installed, and runable on it, a content processing operation protocol software which is capable of identifying the input requirements of input pins of the CPOs, and which can enable the characteristics of outputs of the CPOs to be identified; and which processor also has installed and runable on it CPO binding software which is adapted to reserve the operation of one CPO and provide its output to another CPO, and which has the protocol necessary to promise the services of one CPO to another CPO, the CPO binding software being able to interpret and use the characteristics of the CPOs expressed in the CPO protocol to determine that it is appropriate to link the one CPO with the other CPO to produce a desired overall function.

2. The computer processor and associated computer memory of claim 1 further comprising software adapted to search a library of available existing CPOs, wherein the existing CPOs either operate natively using a translation protocol, or have their native interface wrapped by a translation protocol wrapper.

3. The computer processor and associated computer memory of claim 1 further comprising software adapted to wrap the existing CPOs in a translation protocol interface individually, or interpose a translation protocol interface between a plurality of existing CPOs and the rest of a network.

4. The computer processor and associated computer memory according to claim 1 further comprising a demand director adapted to ascertain whether a library of known existing CPOs includes a CPO that has been requested by a user, and if so, the demand director is adapted to cause a selected CPO to perform the particular CPO on the specific content.

5. The computer processor and associated computer memory according to claim 4 wherein if the demand director ascertains that the requested CPO does not already exist in the available library of existing CPOs, or if it does exist but the existing desired CPO is not available for some reason, the demand director is adapted to cause a new CPO to be created.

6. The computer processor and associated computer memory according to claim 4 wherein the demand director is adapted to determine which combination of existing CPOs are needed, in what order, to perform the requested CPO.

7. The computer processor and associated computer memory according to claim 5 wherein the demand director is adapted to cause the identified existing CPOs to be linked in the necessary way to produce the requested CPO.

8. The computer processor and associated computer memory according to claim 4 wherein the demand director is adapted to use the library of existing CPOs to determine a work flow path for data to be processed, and instruct the existing CPOs to operate in series and/or parallel on the data in a specified order to produce the desired CPO.

9. The computer processor and associated computer memory according to claim 1 wherein a CPO requires data that is to be processed to be typed, and comprises software adapted to establish a contract with a CPO to perform an operation on data and evaluate the type of data to ensure compatibility.

10. A method of making a computer program product comprising: determining what the software is to be able to do;
establishing that at least elements of functionality which can be used to deliver the functionality required can be produced using content processing operations (CPOs) that are already in existence and that are available for use;
creating a software interface container for at least some CPOs which interacts with the said at least some existing CPOs to expose their properties in a common format, non-native to said at least some CPOs; and
using the non-native interface container to mediate communication between a plurality of said at least some CPOs so as to produce a software program product which uses interactions between said existing CPOs to perform the functionality required of the computer program product.

11. The method of claim 10 further comprising searching a library of available existing CPOs that either operate natively using a translation protocol, or have their native interface wrapped by a translation protocol wrapper.

12. The method of claim 10 further comprising wrapping the existing CPOs in a translation protocol interface individually, or interposing a translation protocol interface between a plurality of existing CPOs and the rest of a network.

13. The method according to claim 10 further comprising using a demand director to ascertain whether a library of known existing CPOs includes a CPO that has been requested by a user, and if so causing a selected CPO to perform the particular CPO on the specific content.

14. The method according to claim 13 wherein if the demand director ascertains that the requested CPO does not already exist in the available library of existing CPOs, or if it does exist but the existing desired CPO is not available for some reason, the method comprises causing a new CPO to be created.

15. The method according to claim 13 further comprising using the demand director to determine which combination of existing CPOs are needed, in what order, to perform the requested CPO.

16. The method according to claim 15 further comprising using the demand director to cause the determined existing CPOs to be linked in the necessary way to produce the requested CPO.

17. The method according to claim 13 further comprising the demand director using the library of existing CPOs to determine a work flow path for data to be processed, and instructing the existing CPOs to operate in series and/or parallel on the data in a specified order to produce the desired CPO.

18. The method according to claim 10 wherein a CPO requires data that is to be processed to be typed, and wherein the establishment of a contract with a CPO to perform an operation on data includes evaluating the type of data to ensure compatibility.

19. A method of using a plurality of existing content processing operations (CPOs) to perform a composite content processing operation, the CPOs having API's which require inputs and/or outputs to be in different formats, the method comprising expressing the inputs and outputs of each API in a common format by interposing a translation container between CPOs and their interaction with the rest of a computer system, each translation container expressing the input(s), needed for its CPO, and the output(s) provided by its CPO, in a common format that is not the native format for the CPO with which it interfaces.

20. A computer-implemented method of making software instructions to perform a function made from a plurality of content processing operations, the method comprising using a library of a plurality of content processing operations each with their functionality and input requirements expressed in a common format, this common format being achieved by: using a translation wrapper on native content processing operations which have their functionality and/or input requirements expressed in a native format that is not said common format to expose to a computer system the functionality and input requirements in terms of the common format; and
using binding manager functionality software to negotiate an operation binding contract between the operation of a first content processing operation and the operation of a second content processing operation so as to cause one of the CPOs to provide processed data to another of the CPOs, in use.

21. A process for data content processing comprising combining existing content processing operations which interact with inputs or outputs from each other, and which do so via an intermediary translation protocol which interfaces their own native input/output protocol and translates their requirements or product characteristics into the translation protocol which is operable with all of the existing CPOs, the output of a first existing CPO being provided as an input to a second existing CPO which produces an output using the input from the first CPO.
